(19) United States
(12) Patent Application Publication
(10) Pub. No.: US 2005/0125634 A1
(43) Pub. Date: Jun. 9, 2005

(54) Processor and instruction control method

(75) Inventor: Takaharu Ishizuka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/028,338

(22) Filed: Jan. 4, 2005

Related U.S. Application Data
(63) Continuation of application No. PCT/JP02/10370, filed on Oct. 4, 2002.

(51) Int. Cl. G06F 15/00

(52) U.S. Cl. 712/218; 712/219; 712/235

(57) ABSTRACT

The processor issues instructions including a branch instruction under a first identifier (ID=0) and speculatively executes the instructions by branch prediction. In the event of the detection of a branch error, the processor issues instructions in the correct direction under a second identifier (ID=1) subsequently to the erroneously issued instructions. After the completion of all the instructions prior to the branch error, the processor cancels the instructions erroneously issued by branch prediction to resume the issuance of instructions in the correct direction. The processor updates the identifiers (IDs) attached to the instructions after the occurrence of a branch error. This allows the processor to issue instructions in the correct direction without waiting for the completion of all the instructions prior to the branch instruction that caused the branch error, thus ensuring enhanced processing performance. Moreover, the processor needs only at least two identifiers to be attached to the instructions. This allows reduction in hardware volume.

This application is a continuation of PCT/JP02/010370, filed Oct. 10, 2002.

### TECHNICAL FIELD

The present invention relates to a processor and instruction control method adapted to speculatively execute instructions by branch prediction, and more particularly, to a processor and instruction control method adapted to efficiently cancel subsequent instructions in the event of a failed branch prediction.

### BACKGROUND ART

Conventional processors using both branch prediction and dynamic pipelining are provided with an in-order instruction issuing unit dependent on the program order, an out-of-order instruction execution unit not dependent on the program order and an in-order instruction determination unit dependent on the program order to speculatively execute instructions based on branch prediction. That is, the instruction issuing unit fetches and decodes a plurality of instructions in order so as to cause instruction storage queues of an instruction storage unit to hold opcodes and operands. The instruction execution unit speculatively executes instructions out of order and obtains the results as soon as all the operands are available in the instruction storage unit and calculation units are ready for use. The instruction determination unit holds incomplete instructions in a reorder buffer. When the branch prediction is correct, the results of the instructions subsequent to the branch are considered valid and the instructions are written from the reorder buffer to a register or memory. In the case of a branch error resulting from the failed branch prediction, all the instructions subsequent to the branch are considered invalid and removed from the instruction storage unit and the reorder buffer. Here, the reorder buffer manages the instructions with a reorder map assigned as a substitute for practical registers used by the instruction issuing unit to issue instructions. The reorder buffer holds the results of instructions executed out of order for a period of time during which the instruction determination unit waits before writing the results thereof to a practical register. Therefore, if the branch prediction fails, the reorder buffer turns off the valid bit in the map, i.e., the bit that is assigned to the instructions subsequent to the branch.

FIGS. 1A to 1C show the processings carried out by a conventional processor in the event of a branch error. We assume that a branch error 200 is detected as a result of the failed branch prediction of a branch instruction B4 during the speculative execution of instructions by branch prediction shown in FIG. 1A. When all the instructions prior to the branch instruction B4 are complete as shown in FIG. 1B, the processor proceeds with a cancellation processing 202 to cancel erroneously executed instructions 5 to 8 after the updating of resources including the reorder buffer is complete. Then, the processor starts issuing instructions 50 and 51 in the correct direction and executes the string of instructions as shown in FIG. 1C.

With such instruction control, however, the issuance of a correct instruction string cannot be resumed unless the instructions prior to the branch instruction B, i.e., the instruction that caused the branch error, are completed. This results in a low instruction execution performance. For this reason, the instruction control as illustrated in FIGS. 2A to 2C is employed to deal with the occurrence of a branch error so as to improve the processor's processing performance. In this instruction control, IDs 0, 1 and 2 are assigned as identifiers to the strings of instructions separated by branch instructions B4 and B8 as shown in FIG. 2A. If a branch error 204 of the branch instruction B4 is detected in FIG. 2B, the processor proceeds with a cancellation processing 206 to cancel instructions 5 to 11 having the IDs 1 and 2, newer than the ID 0 of the branch instruction B4. Then, the processor starts issuing the instructions 50 and 51 in the correct direction and executes the strings of instructions as shown in FIG. 2C. This allows the processor to resume the execution of the correct instruction string even if the instructions prior to the branch instruction B4, i.e., the instruction that caused the branch error 204, have yet to be completed, thus ensuring enhanced instruction processing performance. With the instruction control in FIGS. 1A to 1C, however, as many IDs as the number of branch instructions are required to concurrently execute a number of branch instructions. This leads to increased hardware volume and complexity, making the above instruction control unfit for speeding up the processor. In the case of a processor using a renaming scheme, a snapshot of rename information is required for each branch instruction. This similarly leads to increased hardware volume and complexity, making such instruction control unfit for speeding up the processor. This problem can be described in detail as follows.

FIG. 3 is an explanatory view of a rename map used in a conventional processor. Description will be given assuming, for example, that renamable registers REG0, REG1, REG2 and REG3 and reorder buffers ROB0, ROB1, ROB2 and ROB3, i.e., the buffers used to rename the registers, are available. A rename map 210 is a table indexing a register number REG_AD 212 as entry numbers 0 to 3. If a valid bit field AV 216, contains “1”, this denotes that the register is being renamed by the reorder buffer ROB indicated by a reorder buffer address ROB_AD field 214. When the register REG1 is renamed with the reorder buffer ROB3 as a result of the issuance of instructions, “1” is written to the valid flag AV field 216 with entry “1” in the rename map and “3” to the reorder buffer address ROB_AD field 214. When the renaming ends as a result of the completion of the instructions, the valid flag AV field 216 is rewritten to “0” to release the reorder buffer ROB3. Further, to rename the same register REG1 with the different reorder buffer ROB0 before releasing the reorder buffer ROB3, only the reorder buffer address ROB_AD field 214 is rewritten to “0” in the rename map. The valid flag AV field 216 is rewritten to “0” when the instruction that last renamed the register REG1 is completed. For this reason, if an ID is assigned as identifier to each of the instruction strings separated by branch instructions as in the instruction control of FIGS. 2A to 2C, the reorder buffer address ROB_AD field 214 must be assigned to each branch instruction in the case of the rename map 210 as shown in FIG. 3. Moreover, another field must be created for the valid flag AV in an intermediate state. This results in increased hardware volume and complexity, making this instruction control unfit for speeding up the processor. With such speculative instruction execution, the instructions issued assuming no occurrence of an exception and executed speculatively become invalid in the event of an exception as a result of the execution of an instruction. This leads to a similar problem as in the case of a branch error.

It is an object of the present invention to provide a processor and instruction control method that allows the quick resumption of the issuance of instructions in the event of an erroneous speculative execution while requiring only a small hardware volume.

### DISCLOSURE OF THE INVENTION

(Processor Operable to Control Branch Prediction)

A first embodiment of a processor in accordance with the present invention is a processor comprising a first instruction control unit operable to issue instructions including a branch instruction with a first identifier (ID=0) attached thereto and speculatively execute the instructions by branch prediction; a second instruction control unit operable to issue instructions in the correct direction with a second identifier attached thereto subsequent to the erroneously issued instructions upon the detection of a branch error; and a third instruction control unit operable, after the completion of all the instructions prior to the branch instruction, to cancel the instructions erroneously issued by branch prediction and start issuing instructions in the correct direction. Thus, the processor of the present invention updates the identifiers (IDs) attached to instructions after a branch error occurs. This allows the processor to issue instructions in the correct direction without waiting for the completion of all the instructions prior to the branch instruction that caused the branch error, thus ensuring improved instruction processing performance. Besides, the processor needs only at least two identifiers to be attached to the instructions. This achieves two goals: improving the processing performance and reducing the hardware volume.

A second embodiment of the processor in accordance with the present invention is identical to the first embodiment in that it comprises a first instruction control unit operable to issue instructions including a branch instruction with a first identifier (ID=0) attached thereto and speculatively execute the instructions by branch prediction; and a second instruction control unit operable to issue instructions in the correct direction with a second identifier (ID=1) attached thereto subsequent to the erroneously issued instructions upon the detection of a first branch error, but differs therefrom in that it further comprises a third instruction control unit operable, in the event of the detection of a second branch error in an earlier branch instruction after the issuance of instructions in the correct direction following the detection of the first branch error, to cancel in response to the completion of all the instructions prior to the earlier branch instruction all the subsequent instructions and start issuing instructions in the correct direction. As described above, if, after the start of the issuance of instructions in the correct direction in response to a first branch error, another branch error occurs in a branch instruction earlier than the first error, the processor of the present invention can wait for the completion of all the instructions prior to the earlier branch instruction and thereafter cancel all the incomplete instructions to issue instructions in the correct direction. Similarly in this case, the processor needs only at least two identifiers to be attached to the instructions. This allows reduction in hardware volume.

A third embodiment of the processor in accordance with the present invention is identical to the first embodiment in that it comprises a first instruction control unit operable to issue instructions including a branch instruction with a first identifier (ID=0) attached thereto and speculatively execute the instructions by branch prediction; and a second instruction control unit operable to issue instructions in the correct direction with a second identifier (ID=1) attached thereto subsequent to the erroneously issued instructions upon the detection of a first branch error; but differs therefrom in that it further comprises a third instruction control unit operable, in the event of the detection of a second branch error in an earlier branch instruction after the issuance of instructions in the correct direction following the detection of the first branch error, to cancel the instructions issued in the presumably correct direction as a result of the detection of the first branch error and thereafter start issuing instructions in the correct direction determined based on the detection of the second branch error; and a fourth instruction control unit operable, after the issuance of instructions in the correct direction as a result of the detection of the second branch error, to cancel in response to the completion of all the instructions prior to the earlier branch instruction the instructions that were erroneously issued based on the second branch prediction, and resume issuing instructions in the correct direction. As described above, if, after the start of the issuance of instructions in the correct direction in response to a first branch error, another branch error occurs in a branch instruction earlier than the first error, the processor of the present invention can cancel all the incomplete instructions issued erroneously in response to the first branch error to issue instructions in the correct direction without waiting for the completion of all the instructions prior to the earlier branch instruction. Thereafter, the processor can wait for the completion of the instructions prior to the earlier branch instruction and thereafter cancel the erroneously issued incomplete instructions to issue instructions in the correct direction, thus offering improved processing performance. Moreover, the processor needs only at least two identifiers to be attached to the instructions. This allows reduction in hardware volume.

A fourth embodiment of the processor in accordance with the present invention is identical to the first embodiment in that it comprises a first instruction control unit operable to issue instructions including a branch instruction with a first identifier attached (ID=0) thereto and speculatively execute the instructions by branch prediction; and a second instruction control unit operable to issue instructions in the correct direction with a second identifier (ID=1) attached thereto subsequent to the erroneously issued instructions upon the detection of a first branch error; but differs therefrom in that it additionally comprises a third instruction control unit operable, in the event of the detection of a second branch error in a new branch instruction which is one of the instructions issued in the presumably correct direction after the start of the issuance of instructions in the correct direction following the detection of the first branch error, to cancel in response to the completion of all the instructions prior to the new branch instruction all the subsequent instructions and start issuing instructions in the correct direction. As described above, if, after the start of issuance of instructions in the correct direction in response to a first branch error, another branch error is occurs in a new branch instruction within the string of instructions in the correct direction, the processor can wait for the completion of the instructions prior to the new branch instruction and thereafter cancel the incomplete instructions to issue instructions in the correct direction. Similarly in this case, the processor needs only at least two identifiers to be attached to the instructions. This allows reduction in hardware volume.

A fifth embodiment of the processor in accordance with the present invention is identical to the first embodiment in that it comprises a first instruction control unit operable to issue instructions including a branch instruction with a first identifier (ID=0) attached thereto and speculatively execute the instructions by branch prediction; and a second instruction control unit operable to issue instructions in the correct direction with a second identifier (ID=1) attached thereto subsequent to the erroneously issued instructions upon the detection of a first branch error; but differs therefrom in that it additionally comprises a third instruction control unit operable, in the event of the detection of a second branch error in a new branch instruction which is one of the instructions issued in the presumably correct direction after the start of the issuance of instructions in the correct direction following the detection of the first branch error, to cancel, in response to the completion of all the instructions prior to the earlier branch instruction that caused the first branch error while disabling the issuance of instructions in the correct direction, the instructions that were erroneously issued based on the earlier branch instruction, and enable the issuance of instructions to start issuing instructions in the correct direction; and a fourth instruction control unit operable, after the start of the issuance of instructions in the correct direction determined based on the detection of the second branch error, to cancel in response to the completion of all the instructions prior to the new branch instruction the instructions that were erroneously issued as a result of the detection of the first branch error, and resume issuing instructions in the correct direction based on the second branch error. As described above, if, after the start of the issuance of instructions in the correct direction in response to a first branch error, another branch error occurs in a new branch instruction within the string of instructions in the correct direction, the processor can cancel all the incomplete instructions erroneously issued in response to the first branch error to issue instructions in the correct direction without waiting for the completion of all the instructions prior to the new branch instruction. Thereafter, the processor can wait for the completion of the instructions prior to the new branch instruction and thereafter cancel the erroneously issued incomplete instructions to issue instructions in the correct direction, thus offering improved processing performance. Moreover, the processor needs only at least two identifiers to be attached to the instructions. This allows reduction in hardware volume.

The processors of the first to fifth embodiments further comprise a rename map having, for each of entries referenced by register numbers used by instructions, an address storage area of a reorder buffer used for renaming and a plurality of valid flag areas corresponding to a plurality of identifiers attached to the instructions; and a renaming processing unit operable, when renaming the registers used by the instructions with the reorder buffer, to store the address of the reorder buffer used for the renaming in the entry of the rename map referenced by the register number, turn on the valid flag corresponding to the identifier attached to the instructions, turn off the valid flag of the rename map corresponding to the identifier attached to the erroneously issued instructions in the event of the detection of a branch error, and turn on the valid flag of the rename map corresponding to the identifier attached to the instructions issued in the correct direction, wherein the instructions issued in the correct direction as a result of the detection of a branch error are prevented from using rename information derived from the erroneously issued instructions.

(Branch Prediction Instruction Control Method)

A first embodiment of an instruction control method for a processor in accordance with the present invention comprises:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a branch error; and
a third step, after the completion of all the instructions prior to the branch instruction, of canceling the instructions erroneously issued by branch prediction and starting issuing instructions in the correct direction.

A second embodiment of the instruction control method for a processor in accordance with the present invention comprises:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error; and
a third step, in the event of the detection of a second branch error in an earlier branch instruction after the issuance of instructions in the correct direction following the detection of the first branch error, of canceling in response to the completion of all the instructions prior to the earlier branch instruction all the subsequent instructions and start issuing instructions in the correct direction.

A third embodiment of the instruction control method for a processor in accordance with the present invention comprises:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error;
a third step, in the event of the detection of a second branch error in an earlier branch instruction after the issuance of instructions in the correct direction following the detection of the first branch error, of canceling the instructions issued in the presumably correct direction as a result of the detection of the first branch error and thereafter starting issuing instructions in the correct direction determined based on the detection of the second branch error; and a fourth step, after the issuance of instructions in the correct direction as a result of the detection of the second branch error, of canceling in response to the completion of all the instructions prior to the earlier branch instruction the instructions that were erroneously issued based on the second branch prediction, and resuming issuing instructions in the correct direction.

A fourth embodiment of the instruction control method for a processor in accordance with the present invention comprises:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error; and
a third step, in the event of the detection of a second branch error in a new branch instruction which is one of the instructions issued in the presumably correct direction after the start of the issuance of instructions in the correct direction following the detection of the first branch error, of canceling in response to the completion of all the instructions prior to the new branch instruction all the subsequent instructions and starting issuing instructions in the correct direction.

A fifth embodiment of the instruction control method for a processor in accordance with the present invention comprises:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error;
a third step, in the event of the detection of a second branch error in a new branch instruction which is one of the instructions issued in the presumably correct direction after the start of the issuance of instructions in the correct direction following the detection of the first branch error, of canceling, in response to the completion of all the instructions prior to the earlier branch instruction that caused the first branch error while disabling the issuance of instructions in the correct direction, the instructions that were erroneously issued based on the earlier branch instruction, and enabling the issuance of instructions to start issuing instructions in the correct direction; and
a fourth step, after the start of the issuance of instructions in the correct direction determined based on the detection of the second branch error, of canceling in response to the completion of all the instructions prior to the new branch instruction the instructions that were erroneously issued as a result of the detection of the first branch error, and resuming issuing instructions in the correct direction based on the second branch error.

In the instruction control method for a processor of the first to fifth embodiments, in case that a rename map is disposed for each of entries referenced by register numbers used by instructions, the rename map having an address storage area of a reorder buffer used for renaming and a plurality of valid flag areas corresponding to a plurality of identifiers attached to the instructions; the method further comprises:
when the registers used by the instructions are renamed with the reorder buffer, storing the address of the reorder buffer used for the renaming in the entry of the rename map referenced by the register number, and turning on the valid flag corresponding to the identifier attached to the instructions; and
turning off the valid flag of the rename map corresponding to an identifier attached to the erroneously issued instructions in the event of the detection of a branch error, and turning on the valid flag of the rename map corresponding to another identifier attached to the instructions issued in the correct direction, whereby
the instructions issued in the correct direction as a result of the detection of a branch error are prevented from using rename information derived from the erroneously issued instructions.

(Processor Operable to Handle Occurrences of Exceptions)

The processor of the present invention can be used to cancel instructions speculatively executed assuming no occurrence of an exception in the event of an exception as well as to cancel instructions speculatively executed by branch prediction in the event of a branch error. The processor also comprises the following first to fifth embodiments adapted to handle occurrences of exceptions to correspond to the embodiments adapted to handle the detection of branch errors.

The instruction control method of the processor according to the present invention adapted to handle occurrences of exceptions can be used to cancel speculatively executed instructions in the event of an occurrence of an exception as well as to cancel instructions in the event of a branch error. The method also comprises the following first to fifth embodiments adapted to handle occurrences of exceptions to correspond to the embodiments adapted to handle the detection of branch errors.

A first embodiment of a processor handling the occurrence of an exception in accordance with the present invention comprises a first instruction control unit operable to issue instructions including an exception occurrence instruction with a first identifier attached thereto and speculatively execute the instructions assuming no occurrence of an exception; a second instruction control unit operable to issue exception handling routine instructions with a second identifier attached thereto subsequent to the instructions erroneously issued assuming no occurrence of an exception upon the detection of an exception; and a third instruction control unit operable to cancel the exception occurrence instruction and the instructions erroneously issued assuming no occurrence of an exception and start issuing the exception handling routine instructions after the completion of all the instructions prior to the exception occurrence instruction.

A second embodiment of the processor handling the occurrence of an exception in accordance with the present invention comprises a first instruction control unit operable to issue instructions including an exception occurrence instruction with a first identifier attached thereto and speculatively execute the instructions assuming no occurrence of an exception; a second instruction control unit operable to issue exception handling routine instructions with a second identifier attached thereto subsequent to the instructions erroneously issued assuming no occurrence of an exception upon the detection of a first exception; and a third instruction control unit operable, in the event of the detection of a second exception in an earlier instruction after the issuance of exception handling routine instructions in the correct direction following the detection of the first exception, to cancel the exception occurrence instruction and all the subsequent instructions in response to the completion of all the instructions prior to the earlier exception occurrence instruction, and thereafter start issuing exception handling routine instructions based on the detection of the second exception.

A third embodiment of the processor handling the occurrence of an exception in accordance with the present invention comprises a first instruction control unit operable to issue instructions including an exception occurrence instruction with a first identifier attached thereto and speculatively execute the instructions assuming no occurrence of an exception; a second instruction control unit operable to issue exception handling routine instructions with a second identifier attached thereto subsequent to the instructions erroneously issued assuming no occurrence of an exception upon the detection of a first exception; a third instruction control unit operable, in the event of the detection of a second exception in an earlier instruction after the issuance of exception handling routine instructions in the correct direction following the detection of the first exception, to cancel the exception handling routine instructions issued as a result of the detection of the occurrence of the first exception and thereafter start issuing exception handling routine instructions in the correct direction based on the detection of the occurrence of the second exception; and a fourth instruction control unit operable, after the issuance of the exception handling routine instructions following the detection of the occurrence of the second exception, to cancel the instruction that caused the first exception and the instructions erroneously issued assuming no occurrence of an exception in response to the completion of all the instructions prior to the earlier exception occurrence instruction, and thereafter resume the issuance of exception handling routine instructions based on the occurrence of the second exception.

A fourth embodiment of the processor handling the occurrence of an exception in accordance with the present invention comprises a first instruction control unit operable to issue instructions including an exception occurrence instruction with a first identifier attached thereto and speculatively execute the instructions assuming no occurrence of an exception; a second instruction control unit operable to issue exception handling routine instructions with a second identifier attached thereto subsequent to the instructions erroneously issued assuming no occurrence of an exception upon the detection of a first exception; and a third instruction control unit operable, in the event of the detection of a second exception in a new instruction which is one of the exception handling routine instructions after the start of the issuance of exception handling routine instructions in the correct direction following the detection of the first exception, to cancel the exception occurrence instruction and all the subsequent instructions in response to the completion of all the instructions prior to the new exception occurrence instruction, and thereafter start issuing exception handling routine instructions based on the occurrence of the first exception.

A fifth embodiment of the processor handling the occurrence of an exception in accordance with the present invention comprises a first instruction control unit operable to issue instructions including an exception occurrence instruction with a first identifier attached thereto and speculatively execute the instructions assuming no occurrence of an exception; a second instruction control unit operable to issue exception handling routine instructions with a second identifier attached thereto subsequent to the instructions erroneously issued assuming no occurrence of an exception upon the detection of a first exception; a third instruction control unit operable, in the event of the detection of a second exception in a new instruction which is one of the exception handling routine instructions after the start of the issuance of exception handling routine instructions in the correct direction following the detection of the first exception, to cancel the earlier exception occurrence instruction and the instructions that were erroneously issued assuming no occurrence of an exception in response to the completion of all the instructions prior to the earlier exception occurrence instruction that caused the first exception while disabling the issuance of the exception handling routine instructions, and enable the issuance of instructions to start issuing the exception handling routine instructions in the correct direction based on the occurrence of the second exception; and
a fourth instruction control unit operable, after the issuance of the exception handling routine instructions based on the occurrence of the second exception, to cancel the instruction that caused the second exception and the instructions that were issued as the exception handling routine instructions based on the occurrence of the first exception in response to the completion of all the instructions prior to the new exception occurrence instruction, and thereafter resume the issuance of exception handling routine instructions based on the occurrence of the second exception.

(Instruction Control Method Adapted to Handle Occurrences of Exceptions)

The instruction control method of the processor according to the present invention adapted to handle occurrences of exceptions can be used to cancel speculatively executed instructions in the event of an occurrence of an exception as well as to cancel instructions in the event of a branch error. The method also comprises the following first to fifth embodiments adapted to handle occurrences of exceptions to correspond to the embodiments adapted to handle the detection of branch errors.

A first embodiment for handling the occurrence of an instruction control method for a processor according to the present invention comprises:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of an exception; and
a third step of canceling the exception occurrence instruction and the instructions erroneously issued assuming no occurrence of an exception and starting issuing the exception handling routine instructions after the completion of all the instructions prior to the exception occurrence instruction.

A second embodiment for handling the occurrence of the instruction control method for a processor according to the present invention comprises:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception; and
a third step, in the event of the detection of a second exception in an earlier instruction after the issuance of exception handling routine instructions in the correct direction following the detection of the first exception, of canceling the exception occurrence instruction and all the subsequent instructions in response to the completion of all the instructions prior to the earlier exception occurrence instruction, and thereafter starting issuing exception handling routine instructions based on the detection of the second exception.

A third embodiment for handling the occurrence of the instruction control method for a processor according to the present invention comprises:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception;
a third step, in the event of the detection of a second exception in an earlier instruction after the issuance of exception handling routine instructions in the correct direction following the detection of the first exception, of canceling the exception handling routine instructions issued as a result of the detection of the occurrence of the first exception and thereafter starting issuing exception handling routine instructions in the correct direction based on the detection of the occurrence of the second exception; and
a fourth step, after the issuance of the exception handling routine instructions following the detection of the occurrence of the second exception, of canceling the instruction that caused the first exception and the instructions erroneously issued assuming no occurrence of an exception in response to the completion of all the instructions prior to the earlier exception occurrence instruction, and thereafter resuming the issuance of exception handling routine instructions based on the occurrence of the second exception.

A fourth embodiment for handling the occurrence of the instruction control method for a processor according to the present invention comprises:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception; and
a third step, in the event of the detection of a second exception in a new instruction which is one of the exception handling routine instructions after the start of the issuance of exception handling routine instructions in the correct direction following the detection of the first exception, of canceling the exception occurrence instruction and all the subsequent instructions in response to the completion of all the instructions prior to the new exception occurrence instruction, and thereafter starting issuing exception handling routine instructions based on the occurrence of the first exception.

A fifth embodiment for handling the occurrence of the instruction control method for a processor according to the present invention comprises:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception;
a third step, in the event of the detection of a second exception in a new instruction which is one of the exception handling routine instructions after the start of the issuance of exception handling routine instructions in the correct direction following the detection of the first exception, of canceling the earlier exception occurrence instruction and the instructions that were erroneously issued assuming no occurrence of an exception in response to the completion of all the instructions prior to the earlier exception occurrence instruction that caused the first exception while disabling the issuance of the exception handling routine instructions, and thereafter enabling the issuance of instructions to start issuing the exception handling routine instructions in the correct direction based on the occurrence of the second exception; and
a fourth step, after the issuance of the exception handling routine instructions based on the occurrence of the second exception, of canceling the instruction that caused the second exception and the instructions that were issued as the exception handling routine instructions based on the occurrence of the first exception in response to the completion of all the instructions prior to the new exception occurrence instruction, and resuming the issuance of exception handling routine instructions based on the occurrence of the second exception.

### BRIEF DESCRIPTION OF THE DRAWINGS

FIGS. 1A to 1C are explanatory views showing the instruction control operation of a conventional processor in response to a branch error;

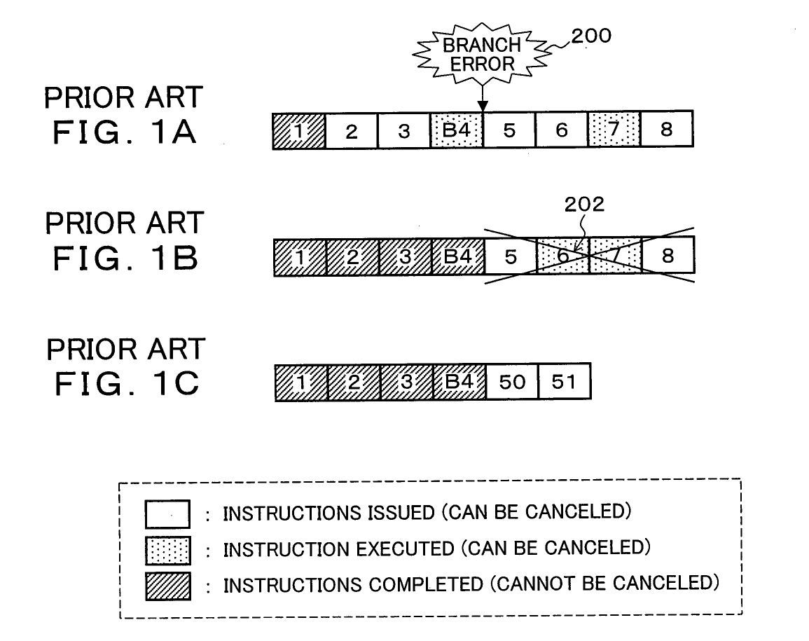

FIGS. 2A to 2C are explanatory views showing the instruction control operation of a conventional processor adapted to attach a different ID to each branch instruction in response to a branch error;

FIG. 3 is an explanatory view of a rename map used by a conventional processor;

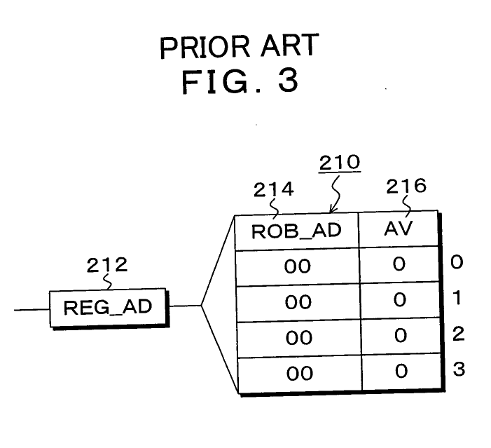

FIG. 4 is a block diagram of a functional configuration of a processor to which the present invention is applied;

FIG. 5 is an explanatory view of the rename map used by the processor of the present invention;

FIGS. 6A and 6B are circuit diagrams comparing the scale of hardware between the present invention and the conventional example in terms of the number of IDs attached to instructions;

FIG. 7 is a block diagram of a first mode branch prediction instruction control unit according to the present invention;

FIGS. 8A to 8C are explanatory views of the instruction control operation according to the embodiment in FIG. 7;

FIG. 9 is a timing chart of the instruction control operation according to the embodiment in FIG. 7;

FIG. 10 is a flowchart of the instruction control according to the embodiment in FIG. 7;

FIG. 11 is a block diagram of a second mode branch prediction instruction control unit according to the present invention;

FIGS. 12A to 12E are explanatory views of the instruction control operation according to the embodiment in FIG. 11;

FIG. 13 is a timing chart of the instruction control operation according to the embodiment in FIG. 11;

FIG. 14 is a flowchart of the instruction control according to the embodiment in FIG. 11;

FIG. 15 is a block diagram of a third mode branch prediction instruction control unit according to the present invention;

FIGS. 16A to 16F are explanatory views of the instruction control operation according to the embodiment in FIG. 15;

FIG. 17 is a timing chart of the instruction control operation according to the embodiment in FIG. 15;

FIG. 18 is a flowchart of the instruction control according to the embodiment in FIG. 15;

FIG. 19 is a block diagram of a fourth mode branch prediction instruction control unit according to the present invention;

FIGS. 20A to 20E are explanatory views of the instruction control operation according to the embodiment in FIG. 19;

FIG. 21 is a timing chart of the instruction control operation according to the embodiment in FIG. 19;

FIG. 22 is a flowchart of the instruction control according to the embodiment in FIG. 19;

FIG. 23 is a block diagram of a fifth mode branch prediction instruction control unit according to the present invention;

FIGS. 24A to 24F are explanatory views of the instruction control operation according to the embodiment in FIG. 23;

FIG. 25 is a timing chart of the instruction control operation according to the embodiment in FIG. 23;

FIG. 26 is a flowchart of the instruction control according to the embodiment in FIG. 23;

FIG. 27 is an instruction control flowchart bringing together the first to fifth mode branch prediction instruction control according to the present invention;

FIG. 28 is a block diagram of a first mode exception occurrence instruction control unit according to the present invention;

FIGS. 29A to 29C are explanatory views of the instruction control operation according to the embodiment in FIG. 28;

FIG. 30 is a flowchart of the instruction control according to the embodiment in FIG. 28;

FIG. 31 is a block diagram of a second mode exception occurrence instruction control unit according to the present invention;

FIGS. 32A to 32E are explanatory views of the instruction control operation according to the embodiment in FIG. 31;

FIG. 33 is a flowchart of the instruction control according to the embodiment in FIG. 31;

FIG. 34 is a block diagram of a third mode exception occurrence instruction control unit according to the present invention;

FIGS. 35A to 35F are explanatory views of the instruction control operation according to the embodiment in FIG. 34;

FIG. 36 is a flowchart of the instruction control according to the embodiment in FIG. 34;

FIG. 37 is a block diagram of a fourth mode exception occurrence instruction control unit according to the present invention;

FIGS. 38A to 38E are explanatory views of the instruction control operation according to the embodiment in FIG. 37;

FIG. 39 is a flowchart of the instruction control according to the embodiment in FIG. 37;

FIG. 40 is a block diagram of a fifth mode exception occurrence instruction control unit according to the present invention;

FIGS. 41A to 41F are explanatory views of the instruction control operation according to the embodiment in FIG. 40;

FIG. 42 is a flowchart of the instruction control according to the embodiment in FIG. 40; and

FIG. 43 is an instruction control flowchart bringing together the first to fifth mode exception occurrence instruction control according to the present invention.

### BEST MODE FOR CARRYING OUT THE INVENTION

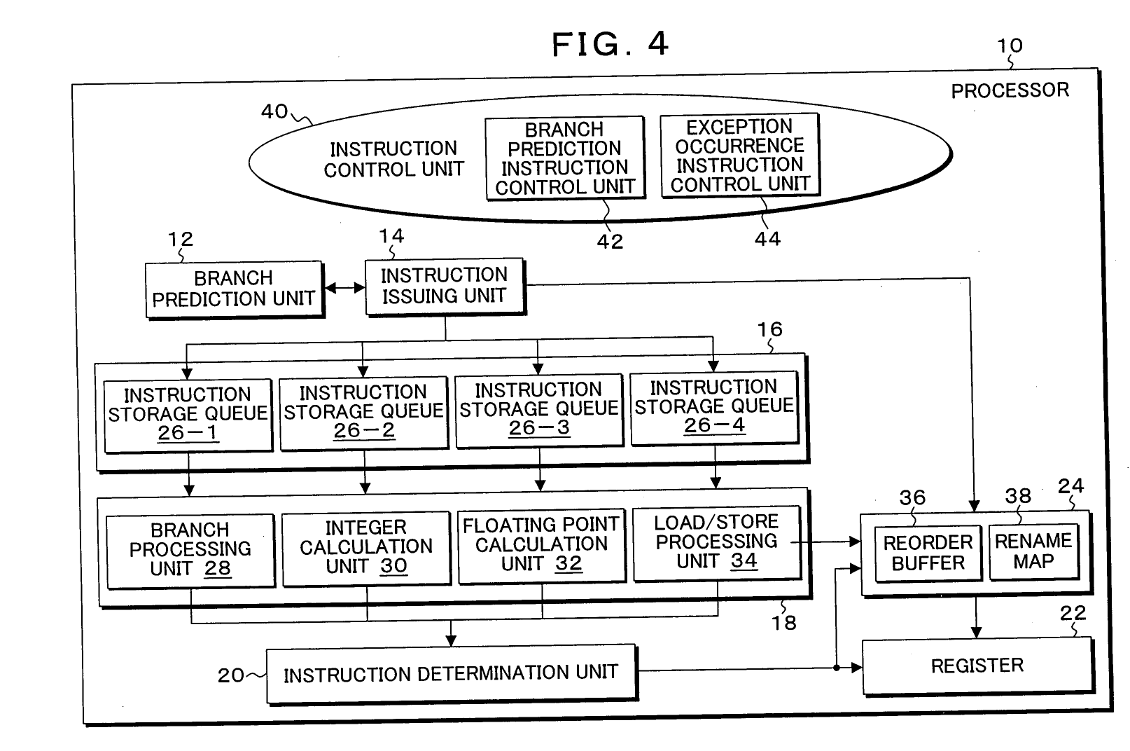

FIG. 4 is a block diagram of a functional configuration of a processor to which the present invention is applied. In FIG. 4, a processor 10 is provided with a branch prediction unit 12, an instruction issuing unit 14, an instruction storage unit 16, an instruction execution unit 18, an instruction determination unit 20, a register 22 and a renaming processing unit 24. The instruction storage unit 16 is provided with instruction storage queues 26-1 to 26-4 that are called reservation stations. The instruction execution unit 18 is provided with functional processing units including a branch processing unit 28, an integer calculation unit 30, a floating point calculation unit 32 and a load/store processing unit 34. Further, the renaming processing unit 24 is provided with a reorder buffer 36 and a rename map 38.

These processing units of the processor 10 operate under the control of an instruction control unit 40. In the present invention, the instruction control unit 40 has a branch prediction instruction control unit 42 and an exception occurrence instruction control unit 44 in addition to an ordinary instruction control unit. The processor 10 in the embodiment of FIG. 4 employs two techniques in combination, so-called dynamic scheduling and branch prediction, to carry out the speculative execution of instructions. First, the instruction issuing unit 14, for example, fetches and decodes four instructions from an instruction cache. Provided with a branch history table for use in the branch prediction, the branch prediction unit 12 speculatively executes the instructions in the predicted branch direction.

The instructions issued in order from the instruction issuing unit 14 are sent together with their operands to the instruction storage unit 16 to correspond to the functional processing units of the instruction execution unit 18. At the same time, the instruction issuing unit 14 registers the instructions in the reorder buffer 36. The instructions sent to the instruction storage unit 16 are executed out of order as soon as the corresponding functional processing units in the instruction execution unit 18 are available. Then, the results of execution are stored in the reorder buffer assigned to the instructions. The instruction determination unit 20 holds all the incomplete instructions in the reorder buffer. Upon receiving the result of the judgment made by the branch processing unit 28 of the instruction execution unit 18 as to whether the branch takes place, the instruction determination unit 20 determines how to process the incomplete instructions based on the result. That is, when the branch prediction is correct, the results of the execution of the instructions following the branch instruction are considered to be valid. In this case, the results are written in order, i.e., in the program order, to the register 22 or a memory that is not shown. If a branch error occurs as a result of the failed branch prediction, all the results of the execution of the instructions following the branch instruction are considered to be invalid. In this case, the results are canceled from the instruction storage unit 16 and the reorder buffer 36. Thus, in the event of a branch error detected in the instructions executed speculatively by branch prediction, the branch prediction instruction control unit 42 according to the present invention provided in the instruction control unit 40 efficiently cancels the instructions issued in the wrong direction in response to a branch error and issues instructions in the correct direction based on the error detection.

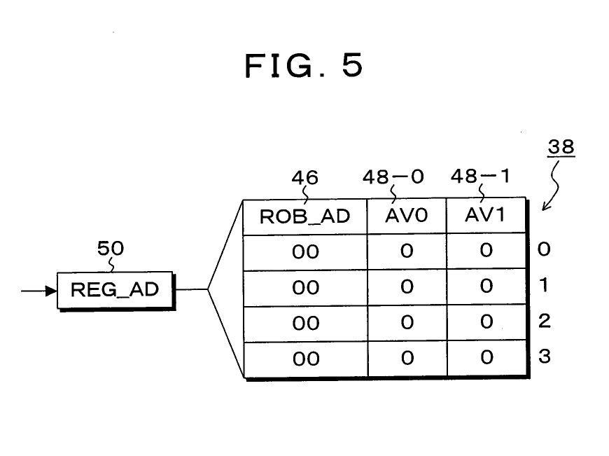

FIG. 5 is an explanatory view of the rename map 38 provided in the renaming processing unit 24 of the processor 10 in FIG. 4. The branch prediction instruction control of the present invention requires only at least two IDs, i.e., ID=0 and 1, as identifiers attached to the instructions.

In correspondence with the two IDs attached to the instructions, the rename map 38 has, in addition to a reorder buffer address field (ROB_AD) 46, a valid flag field (AV0) 48-0 adapted to store a valid flag AV0 corresponding to ID=0 and a valid flag field (AV1) 48-1 adapted to store a valid flag AV1 corresponding to ID=1 for each of entries 0, 1, 2 and 3 shown on the right of the map that are specified by an instruction register number 50. In this rename map 38, the address of the reorder buffer to be renamed (e.g., “00”) is written to the reorder buffer address field 46 of the entry specified by the register number 50 (e.g., entry 0 in the case of register number RG1). When the ID attached to the instructions at this time is ID=0, the flag of the corresponding field in the valid flag field 48-0 is set to “1.” To release a reorder buffer at the completion of the instructions or disable the instructions in the event of the detection of a branch error, it suffices to set the valid flag field 48-0 with ID=0, for example, from “1” to “O.”

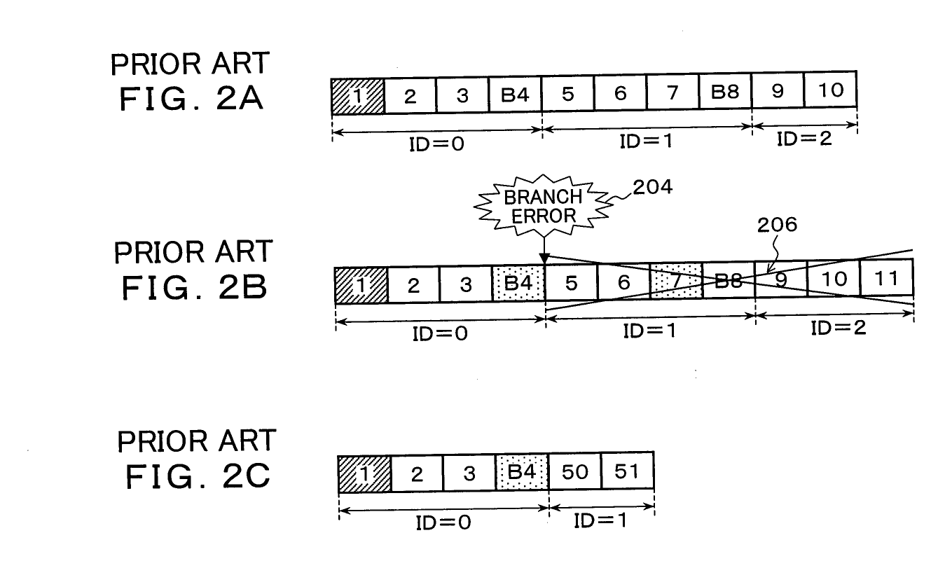

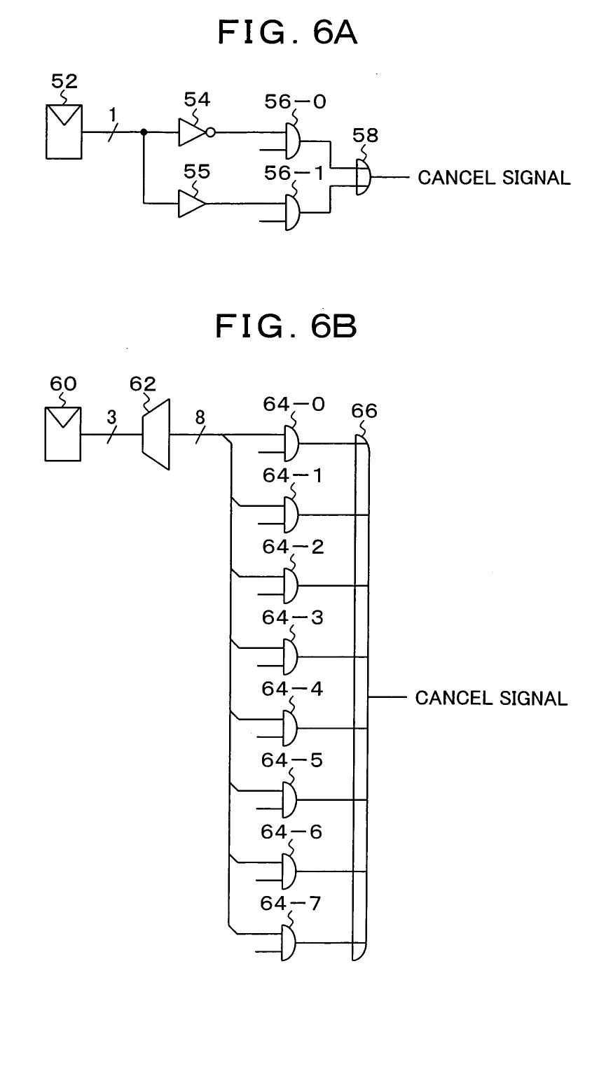

FIGS. 6A and 6B are circuit diagrams of hardware generating a cancel signal adapted to cancel the valid flag fields to “0” in response to the ID attached to the instructions for the rename map 38 in FIG. 5. FIG. 6A shows the circuit that corresponds to two IDs, i.e., ID=0 and 1, in the renamemap 38 in FIG. 5. In contrast, FIG. 6B illustrates a hardware circuit using eight IDs, i.e., ID=0 to 7, in the conventional instruction control shown in FIGS. 2A to 2C. When generating a cancel signal, the circuit of FIG. 6A used in the present invention sets one-bit ID data of the instructions' ID field in a latch 52. When ID=0, the output of an inverter 54 is “1.” As a result, an AND gate 56-0 produces an output “1” when this gate receives an input following the completion or disabling of the instruction with ID=0. This signal is output from an OR gate 58 as cancel signal. On the other hand, when ID=1 of the ID field is held by the latch 52, the output of a buffer 55 is 1. As a result, an AND gate 56-1 produces an output “1” when this gate receives an input following the completion or disabling of the instruction with ID=1. This signal is output from an OR gate 58 as cancel signal. In contrast, the circuit of FIG. 6B used in the conventional instruction control has a three-bit output line for a latch 60 in correspondence with eight IDs=0 to 7. A decoder is provided in the circuit to classify the three-bit information of the instructions' ID field, i.e., the information held by the latch 60, into one of the eight different IDs. As a result, the output of the decoder 62 has eight signal lines. Further, AND gates 64-0 to 64-7 are provided to correspond to eight IDs=0 to 7 following the decoder 62. All the outputs thereof are fed to an OR gate 66 to retrieve a cancel signal. As is apparent from the comparison between the circuit of the present invention in FIG. 6A using two IDs and the conventional circuit using eight IDs in FIG. 6b, the more IDs attached to instructions, the larger the circuit scale becomes that is needed to output a cancel signal. In contrast, the present invention basically requires only two IDs as shown in FIG. 6A. Therefore, it is apparent that the required hardware volume, i.e., the volume of hardware needed to produce a cancel signal following the completion of instructions or disabling thereof as a result of a branch error, can be sufficiently reduced.

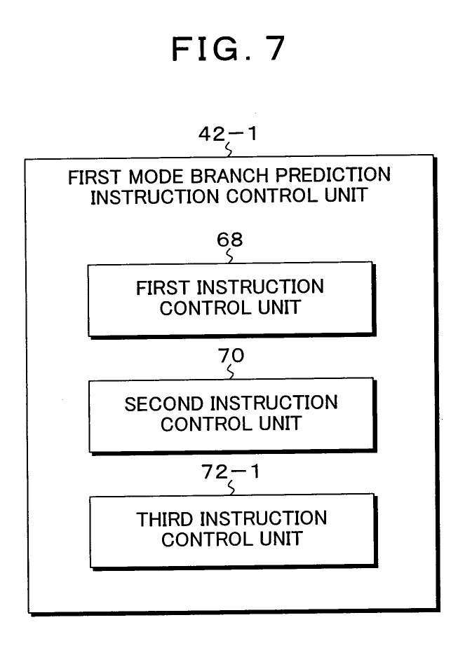

FIG. 7 is a block diagram of a first mode branch prediction instruction control unit 42-1, i.e., a first embodiment of the branch prediction instruction control unit 42 provided in the processor 10 in FIG. 4. The first mode branch prediction instruction control unit 42-1 is provided with first, second and third instruction control units 68, 70 and 72-1.

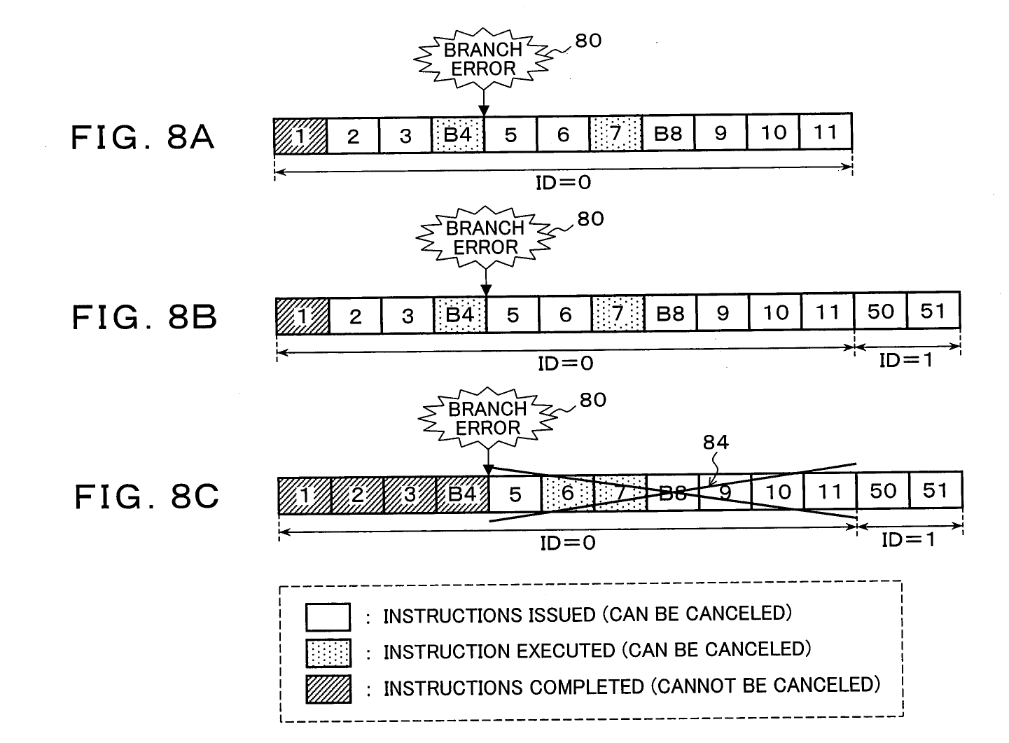

FIGS. 8A to 8C illustrate the instruction control operation carried out by the first mode branch prediction instruction control unit 42-1 in FIG. 7. Referring thereto, the control operation in FIG. 7 can be described as follows. First, the first instruction control unit 68 issues instructions 1 to 11 including branch instructions B4 and B8 under ID=0 as the first identifier as shown in FIG. 8A. As for the branch instruction string B4, the instructions 5 to 11 are issued and speculatively executed in the direction determined by the branch prediction. If, as a result of such speculative execution of the instructions based on the branch prediction, a branch error 80 is detected in the branch instruction B4, the second instruction control unit 70 issues, upon detecting the branch error 80, instructions 50 and 51 in the correct direction under a different ID=1, subsequently to the instructions 5 to 11 that were erroneously issued, as shown in FIG. 8B. Next, the third instruction control unit 72-1 proceeds, as shown in FIG. 8C, with a cancellation processing 84 adapted to cancel the instructions 5 to 11 that were erroneously issued by the branch prediction of the branch instruction B4, after recognizing that the instructions 1 to 4 prior to the branch are completed. Then, the third instruction control unit 72-1 starts issuing instructions in the correct direction subsequently to the instructions 50 and 51. At the time of the cancellation processing 84 of the erroneously issued instructions 5 to 11, the ID=0 attached to the target instructions and the resources assigned thereto are canceled. More specifically, the ID field of the canceled instructions is set in the latch 52 to cause the circuit in FIG. 6A to generate a cancel signal. This cancel signal cancels the erroneously issued instructions 5 to 11 held by the instruction storage unit 16 of the processor 10. At the same time, the signal sets all the entries, i.e., the entries of the valid flag field 48-0 corresponding to ID=0 in the rename map 38 in FIG. 5, to “0.” As a result, the reorder buffer 36, used as a resource of the instructions, is released. As described above, the control operation of the first mode branch prediction instruction control unit attaches a new ID to the instructions issued in the correct direction after the detection of a branch error. Therefore, only two IDs are required: one to cancel the instructions in response to a branch error and the other to issue instructions in the correct direction. This can reduce the hardware volume resulting from ID use to a required minimum.

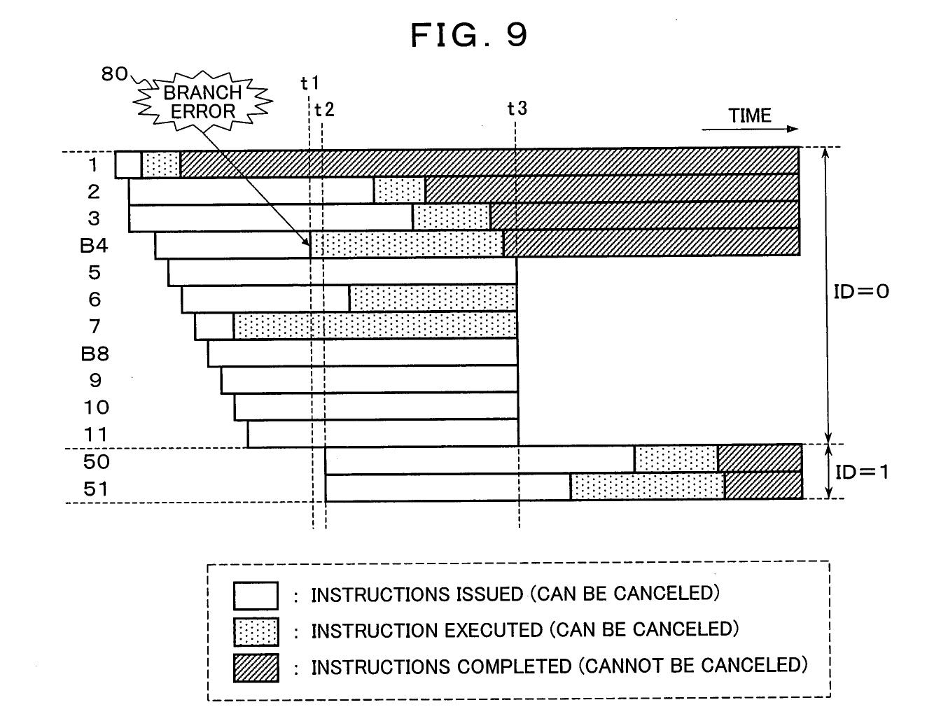

FIG. 9 is a timing chart corresponding to the instruction control operation in FIG. 8, with the issued instructions arranged vertically and the elapsed time shown horizontally. In FIG. 9, after the detection of the branch error 80 in the branch instruction B4 at a time t1, the issuance of the instructions 50 and 51 under ID=1 starts in the correct direction at a time t2, i.e., the time when the issuance and execution of the branch instruction B4 is already complete, as shown in FIG. 8B. Then, the erroneously issued instructions 5 to 11 are canceled at a time t3 after all the instructions up to the branch instruction B4 are completed.

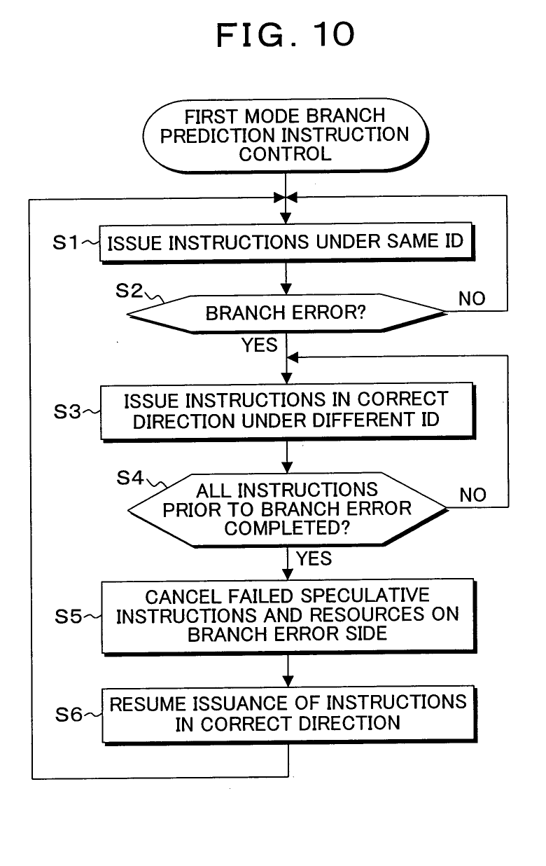

FIG. 10 is a flowchart of the instruction control conducted by the first mode branch prediction instruction control unit 42-1 in FIG. 7. First, the control unit issues instructions under the same ID in step S1. If a branch error occurs in one of the instructions that were already issued and executed in step S2, the control unit issues instructions in the correct direction under a different ID in step S3. Next, the control unit monitors in step S4 whether all the instructions prior to the branch error are completed. If so, the control unit cancels, in step S5, the failed speculative instructions erroneously issued in response to the branch error and the resources thereof including the reorder buffer, and thereafter resumes, in step S6, the issuance of instructions in the correct direction.

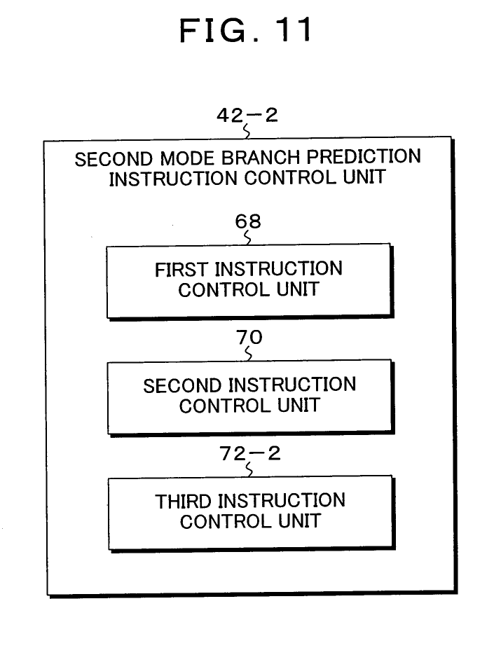

FIG. 11 is a block diagram of a second mode branch prediction instruction control unit 42-2, i.e., a second embodiment of the branch prediction instruction control unit provided in the processor 10 in FIG. 4. The second mode branch prediction instruction control unit 42-2 is provided with the first and second instruction control unit 68 and 70 and a third instruction control unit 72-2. Although, of these units, the control units 68 and 70 are the same as those in the first mode branch prediction instruction control unit 42-1 in FIG. 7, the third instruction control unit 72-2 is characterized in that it handles the instruction control if, during the issuance of instructions in the correct direction in response to a branch error, another branch error occurs in a branch instruction earlier than the first branch error.

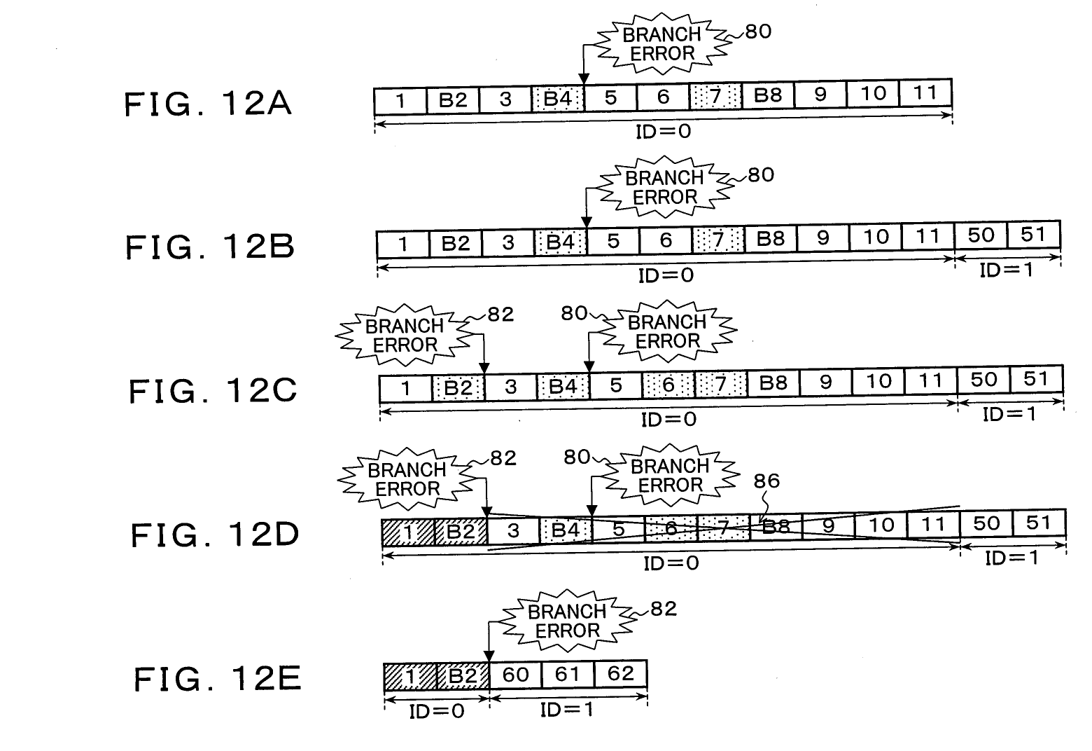

FIGS. 12A to 12E are explanatory views of the control operation carried out by the second mode branch prediction instruction control unit 42-2 in FIG. 11. The first instruction control unit 68 issues the instructions including branch instructions B2, B4 and B8 under ID=0 as shown in FIG. 12A. The branch instructions B2, B4 and B8 are speculatively executed by branch prediction. We assume in this condition that the branch error 80 is detected as a result of the out-of-order execution of the branch instruction B4. In response to the detection of the branch error 80, the second instruction control unit 70 issues the instructions 50 and 51 in the correct direction under a different ID (ID=1) subsequently to the instructions 5 to 11. The control operation of the first and second instruction control units 68 and 70 is the same as already described in FIGS. 8A and 8B. Next, if a branch error 82 is detected as a result of the out-of-order execution of the branch instruction B2, i.e., the instruction earlier than the branch instruction B4 that caused the branch error 80 as shown in FIG. 12C, the third instruction control unit 72-2 waits for the completion of all the instructions prior to the earlier branch instruction B2, i.e., the instructions 1 and B2, and thereafter proceeds with a cancellation processing 86 adapted to cancel the subsequent instructions 3 to 51 as shown in FIG. 12D. This cancellation processing cancels ID=0 and the resources as well. The issuance of instructions 60 to 62 and beyond, i.e., the instructions in the correct direction in response to the branch error 82, will resume after the cancellation processing 86 of the erroneously issued instructions as shown in FIG. 12E. The control operation of the second mode branch prediction instruction control unit 42-2 does not require an ID to be attached to each branch instruction as in the conventional instruction control of FIGS. 2A to 2C. This control operation only requires a different ID to be attached to the instructions issued in the correct direction following the detection of a branch error. As a result, only two IDs are necessary.

This can reduce the volume of hardware operable to generate a cancel signal to a required minimum as shown in FIG. 6A.

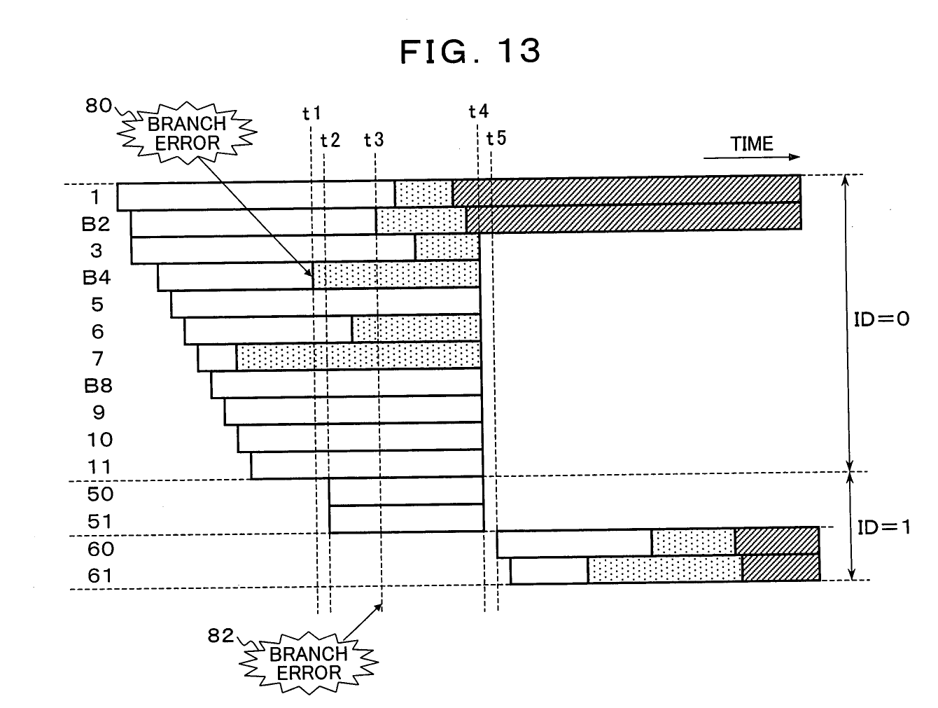

FIG. 13 is a timing chart of the instruction control corresponding to FIGS. 12A to 12E. In FIG. 13, after the detection of the branch error 80 at the time t1 as a result of the execution of the branch instruction B4, the instructions 50 and 51 are issued in the correct direction under a different ID (ID=1) from the time t2. Then, if the branch error 82 is detected at the time t3 as a result of the execution of the branch instruction B2, i.e., the instruction earlier than the branch instruction B4, all the erroneously issued instructions 3 to 51 are canceled at a time t4 after the branch instruction B2 is completed. Then, the issuance of the instructions 60, 61 and beyond in the correct direction begins at a time t5.

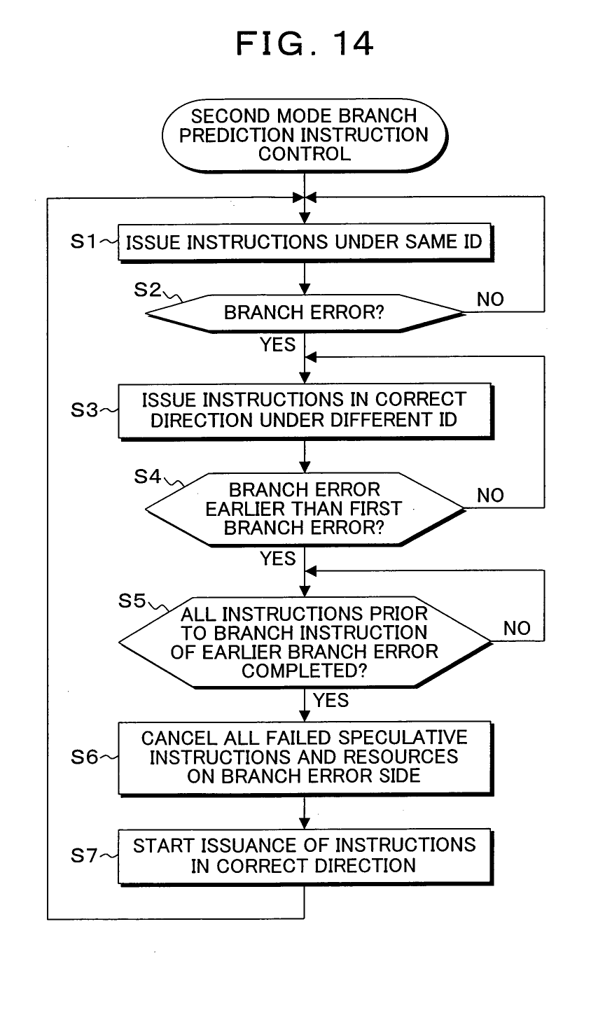

FIG. 14 is a flowchart of the instruction control conducted by the second mode branch prediction instruction control unit 42-2 in FIG. 11. First, the control unit issues instructions under the same ID in step S1. If a branch error occurs as a result of the execution of the branch instruction by branch prediction in step S2, the control unit issues instructions in the correct direction under a different ID in step S3. Next, if a branch error occurs in a branch instruction earlier than the branch instruction that caused the first branch error in step S4, the control unit checks in step S5 whether all the instructions prior to the earlier branch instruction are completed. If so, the control unit cancels all the failed speculative instructions issued erroneously in response to the branch error and the resources thereof including the reorder buffer in step S6 and thereafter starts issuing instructions in the correct direction in step S7.

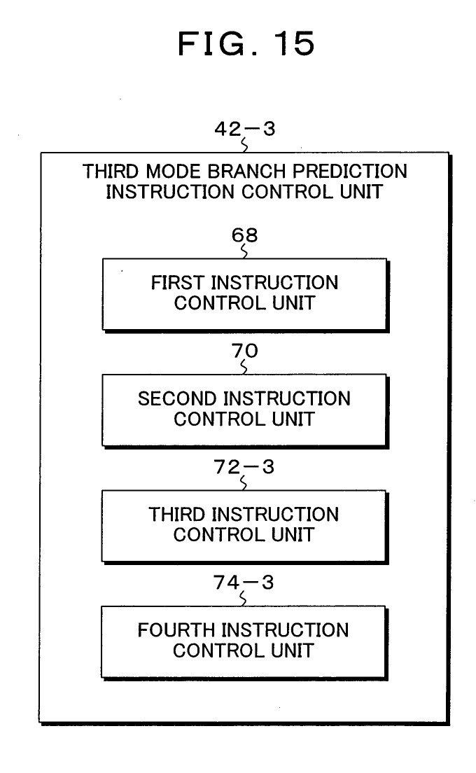

FIG. 15 is a block diagram of a third mode branch prediction instruction control unit 42-3, i.e., a still different embodiment of the branch prediction instruction control unit 42 in FIG. 4. The control unit of this embodiment is provided with the first and second instruction control units 68 and 70 and third and fourth instruction control units 72-3 and 74-3. The first and second instruction control units 68 and 70 are the same as those in the first mode branch prediction instruction control unit 42-1 in FIG. 7. On the other hand, the third and fourth instruction control units 72-3 and 74-3 are characterized in that they handle the instruction control if, during the issuance of instructions in the correct direction in response to a branch error, another branch error occurs in a branch instruction earlier than the first branch error, as with the third instruction control unit 72-2 of the second mode branch prediction instruction control unit 42-2 in FIG. 11.

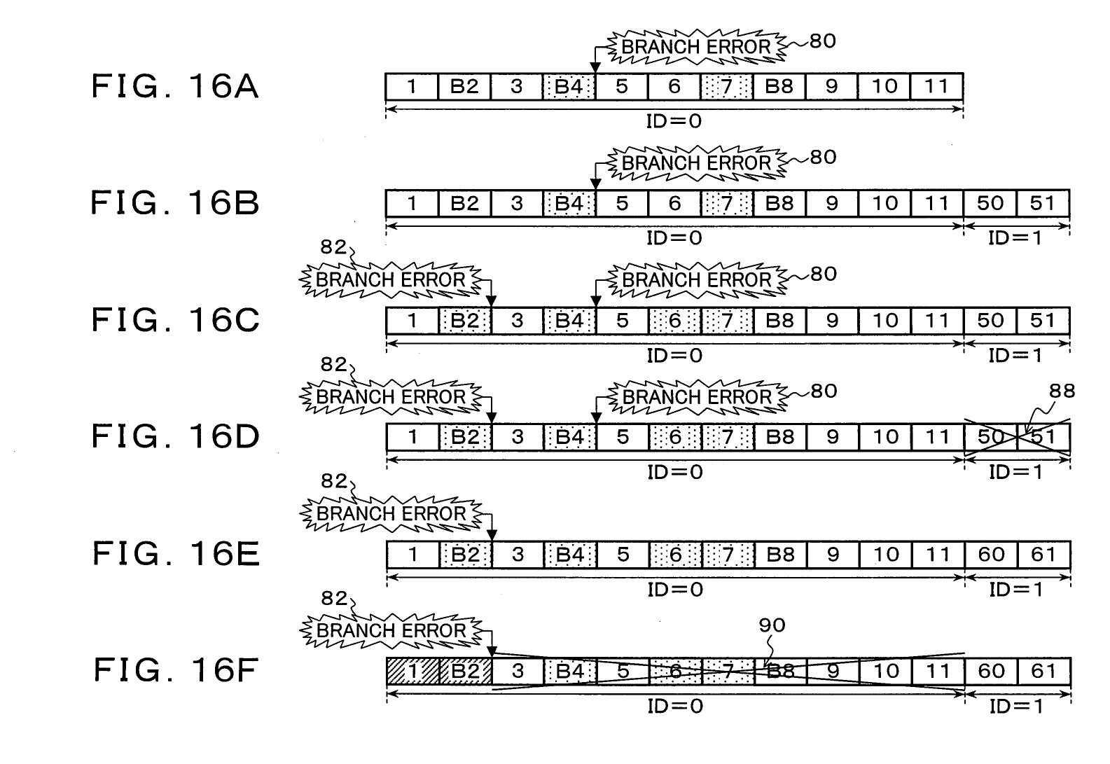

FIGS. 16A to 16F are explanatory views of the control operation carried out by the third mode branch prediction instruction control unit 42-3 in FIG. 15. The control operation shown in FIGS. 16A to 16C is the same as that of the second mode branch prediction instruction control unit 42-2 shown in FIGS. 12A to 12E. That is, if the branch error 80 is detected as a result of the execution of the branch instruction B4 as shown in FIG. 16A, then the instructions 50 and 51 are issued in the correct direction under a different ID (ID=1) subsequently to the instructions 5 to 11 as shown in FIG. 16B. Then, in the event of the detection of the branch error 82 as a result of the execution of the branch instruction B2, i.e., the instruction earlier than the branch instruction B4 that caused the branch error 80, the third instruction control unit 72-3 in FIG. 15 proceeds, as shown in FIG. 16D, with a cancellation processing 88 adapted to cancel the instructions 50 and 51 that were issued in the presumably correct direction in response to the first branch error. Thereafter, this control unit starts issuing, as shown in FIG. 16E, the instructions 60 and 61 that are determined to be in the correct direction based on the detection of the branch error 82. Next, the fourth instruction control unit 74-3 in FIG. 15 waits for the completion of all the instructions prior to the earlier branch instruction string B2, i.e., the instruction strings 1 and B2, and thereafter proceeds with a cancellation processing 90 adapted to cancel the erroneously issued instructions 3 to 11 as shown in FIG. 16E. Then, the control unit 74-3 resumes the issuance of instructions subsequently to the instructions 60 and 61 that were issued in the correct direction. Naturally, the cancellation processing 90 cancels not only the instructions but also ID=0 and the resources at the same time. The control operation is compared between the third mode branch prediction instruction control unit 42-3 in FIGS. 16A to 16F and the second mode branch prediction instruction control unit 42-2 in FIGS. 12A to 12E. Both control units are faced with the same situation, i.e., the detection of the branch error 82 in the earlier branch instruction following the detection of the first branch error 80. The third mode branch prediction instruction control unit 42-3, however, proceeds with the cancellation processing 88 of the instructions 50 and 51 issued in the correct direction in response to the first detected branch error 80 as shown in FIG. 16D when the second branch error 82 is detected. Then, this control unit issues the instructions 60 and 61 in the correct direction in response to the branch error 82 as shown in FIG. 16E. This enables the issuance of instructions at an earlier timing in response to the second branch error 82 than in FIGS. 12A to 12E, thus enhancing the instruction processing performance.

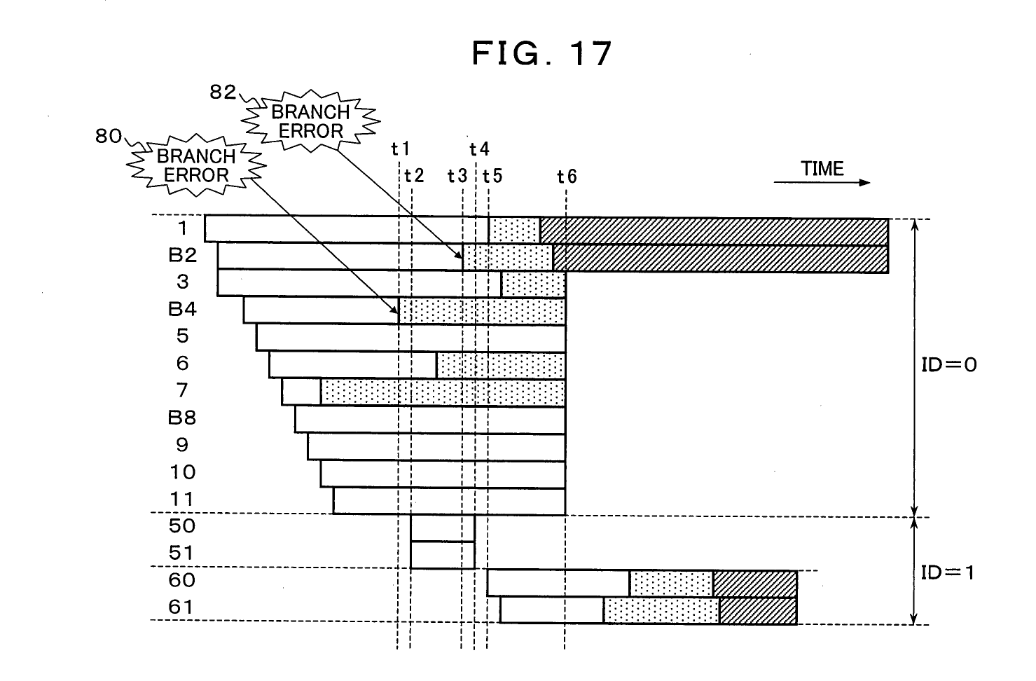

FIG. 17 is a timing chart of the instruction control corresponding to FIGS. 16A to 16F. In FIG. 17, after the detection of the branch error 80 at the time t1 as a result of the execution of the branch instruction B4, the instructions 50 and 51 are issued in the correct direction under a different ID (ID=1) at the time t2. Then, after the detection of the branch error 82 at the time t3 as a result of the execution of the branch instruction B2, i.e., the instruction earlier than the branch instruction B4, the instructions 50 and 51, issued in the correct direction in response to the branch error 80, are canceled later at the time t4. Then, the issuance of the instructions 60 and 61 in the correct direction begins in response to the branch error 82 at the time t5. The timing chart in FIG. 17 is compared with that in FIG. 13 similarly detecting the branch errors 80 and 82. The comparison shows that the instructions 60 and 61, i.e., the instructions issued in the correct direction in the end, are issued at an earlier timing in FIG. 17. As a result, the instruction processing performance is enhanced.

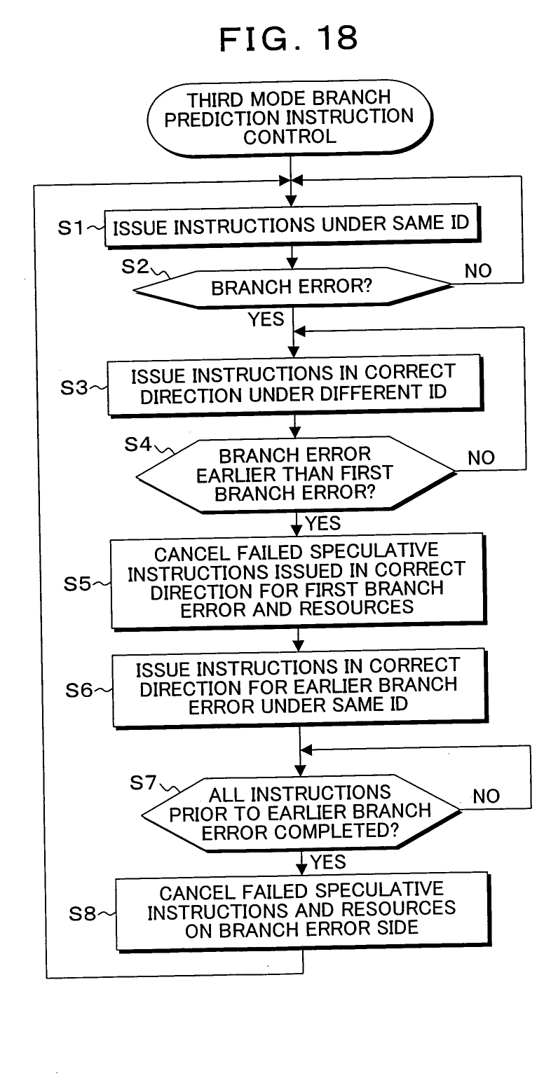

FIG. 18 is a flowchart of the instruction control conducted by the third mode branch prediction instruction control unit 42-3 in FIG. 15. In FIG. 18, the control unit first issues instructions under the same ID in step S1. After the detection of a branch error as a result of the execution of the branch instruction, i.e., one of the instructions issued in step S2, the control unit issues instructions in the correct direction under a different ID in step S3. The control unit checks in step S4 whether a branch error occurs in a branch instruction earlier than the branch instruction that caused the first branch error. If such an error occurs in step S4, the control unit cancels, in step S5, the failed speculative instructions issued in the correct direction in response to the first branch error and the resources including the reorder buffer. Next, the control unit issues, in step S5, instructions in the correct direction in response to the branch error caused by the earlier branch instruction under the same ID as in step S3. Next, the control unit determines, in step S7, whether all the instructions prior to the earlier branch error are completed. If so, the control unit cancels, in step S8, the failed speculative instructions erroneously issued in response to the branch error and the resources thereof.

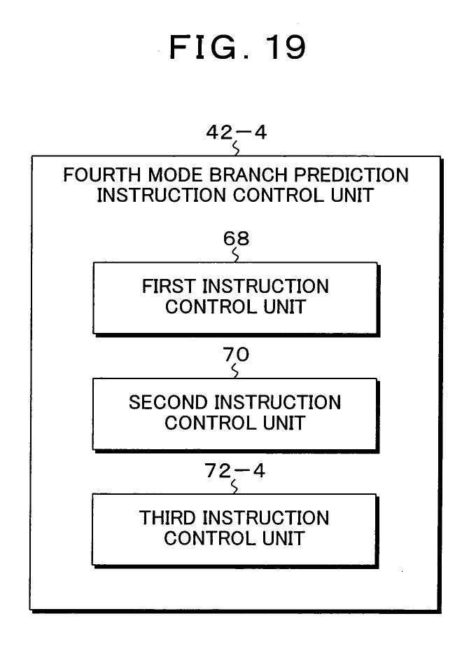

FIG. 19 is a block diagram of a fourth mode branch prediction instruction control unit 42-4, i.e., a fourth embodiment of the branch prediction instruction control unit 42 provided in the processor 10 in FIG. 4. The control unit of this embodiment is provided with the first and second instruction control units 68 and 70 and a third instruction control unit 72-4. The first and second instruction control units 68 and 70 are the same as those in the first embodiment in FIG. 7. On the other hand, the third instruction control unit 72-4 is characterized in that it handles the instruction control if, after the detection of a first branch error as a result of the speculative execution of instructions by branch prediction, a second branch error is detected in a new branch instruction within the instruction string issued in the correct direction in response to the first branch error.

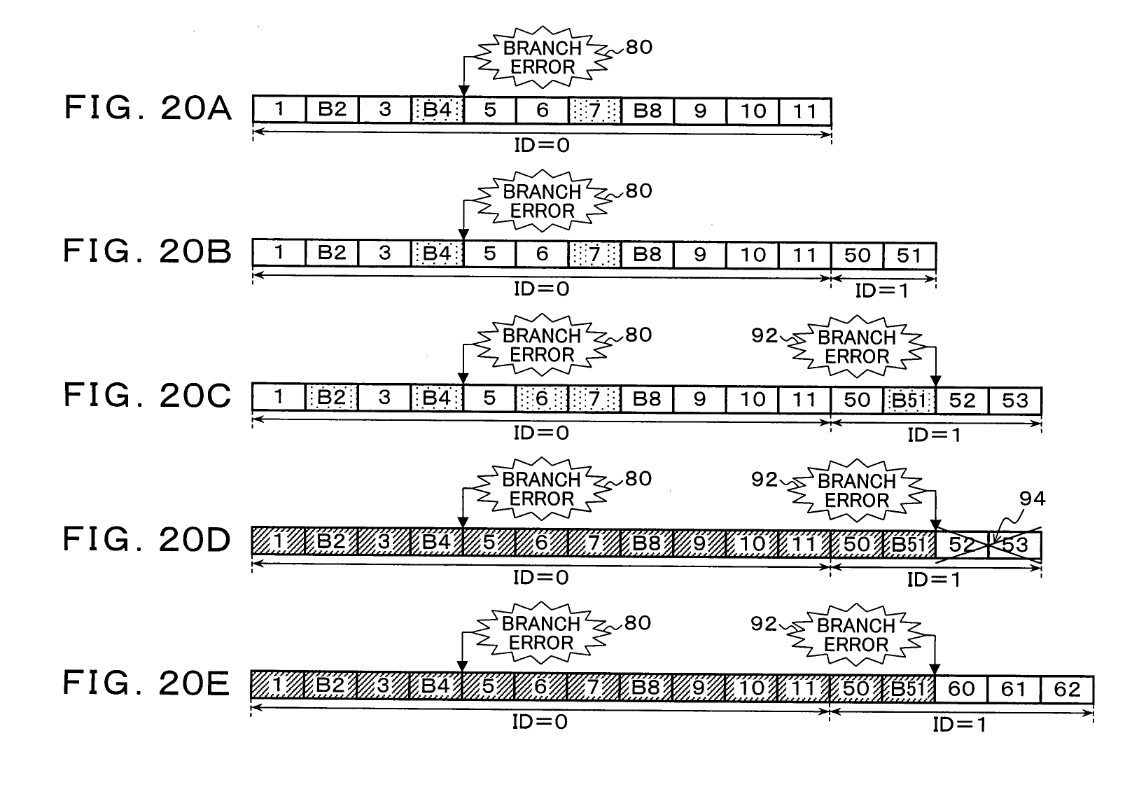

FIGS. 20A to 20E are explanatory views of the control operation carried out by the fourth mode branch prediction instruction control unit 42-4 in FIG. 19. In FIG. 20A, the first instruction control unit 68 issues instructions including the branch instructions B2, B4 and B8, and these branch instructions are speculatively executed by branch prediction. If the branch error 80 is detected as a result of the out-of-order execution of the branch instruction B4, the second instruction control unit 70 issues, as shown in FIG. 20B, the instructions 50 and 51 in the correct direction under a different ID (ID=1) subsequently to the instructions 5 to 11 that were erroneously issued. Next, if a branch error 92 is detected as a result of the execution of a branch instruction B52, i.e., one of the instructions 50 to 53 issued in the correct direction under ID=1, as shown in FIG. 20C, the third instruction control unit 72-4 waits for the completion of all the instructions prior to the branch instruction B52 that caused the branch error 92 and thereafter proceeds with a cancellation processing 94 adapted to cancel the subsequent instructions 52 and 53 as shown in FIG. 20D. Then, this control unit starts issuing, as shown in FIG. 20E, the instructions 60 to 62 and beyond in the correct direction in response to the branch error 92.

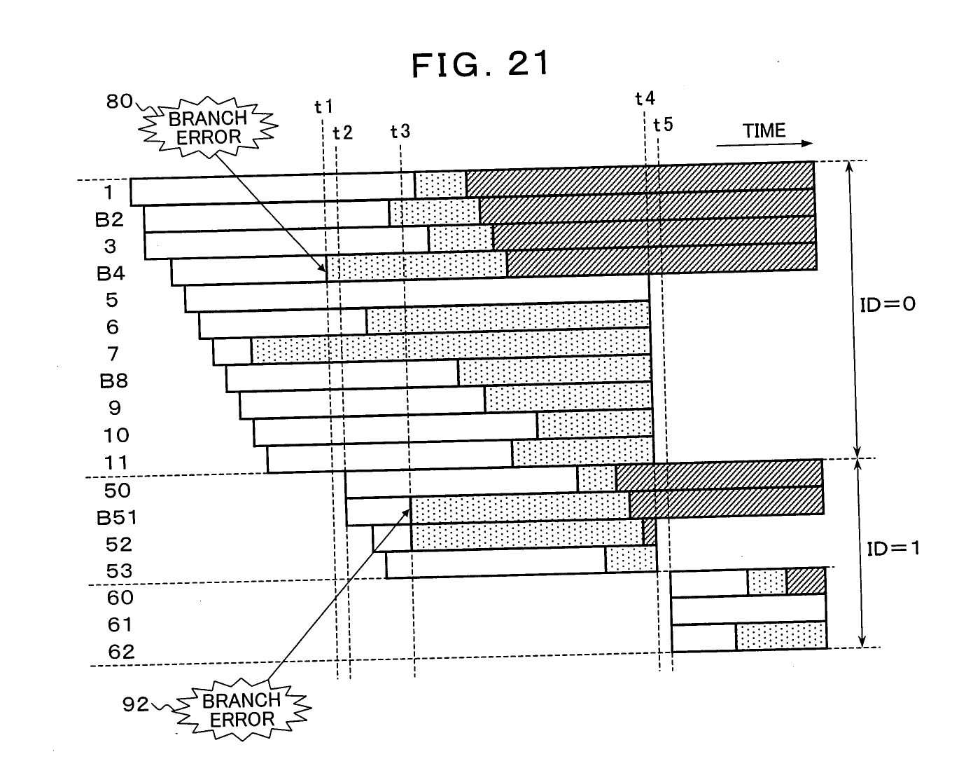

FIG. 21 is a timing chart of the instruction control corresponding to FIGS. 20A to 20E. In FIG. 21, after the detection of the branch error 80 at the time t1 as a result of the execution of the branch instruction B4, the issuance of the instructions 50 to 53 in the correct direction begins under ID=1 at the time t2. Then, after the detection of the branch error 92 as a result of the execution of the branch instruction B52, i.e., one of the instructions issued in the correct direction at the time t3, the third instruction control unit 72-4 waits up to the time t4 for the completion of all the instructions prior to the branch instruction B52 that caused the branch error 92. This control unit starts issuing the instructions 60 to 62 in the correct direction in response to the branch error 92 at the time t5.

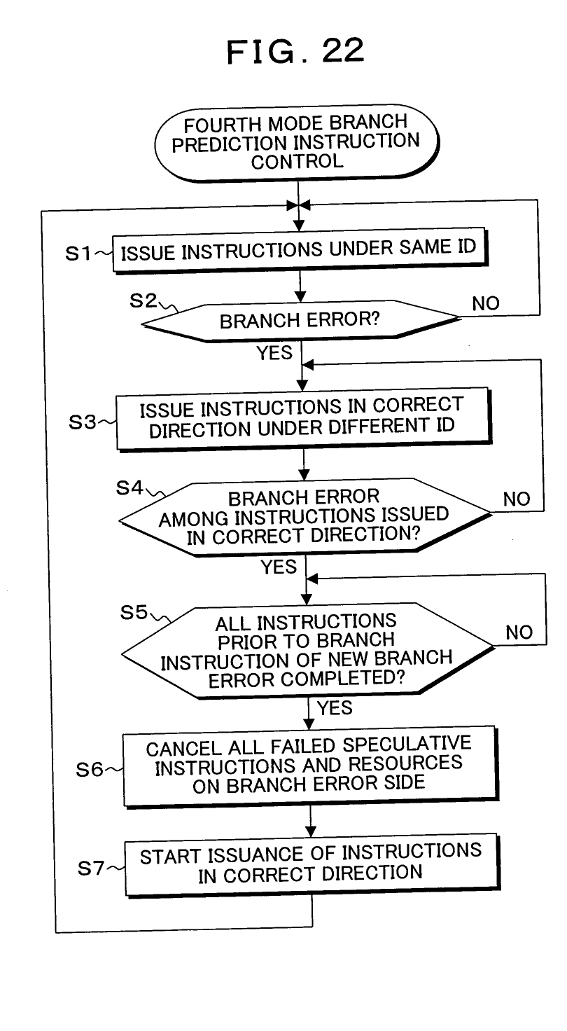

FIG. 22 is a flowchart of the instruction control conducted by the fourth mode branch prediction instruction control unit 42-4 in FIG. 19. In FIG. 22, the control unit first issues instructions under the same ID in step S1. If a branch error is detected as a result of the execution of the branch instruction, i.e., one of the instructions issued in step S2, the control unit issues, in step S3, instructions in the correct direction under a different ID subsequently to the erroneously issued instructions. Next, if a branch error is detected in step S4 as a result of the execution of the branch instruction, i.e., one of the instructions issued in the correct direction in response to the branch error detected in step S2, the control unit checks in step S5 whether all the instructions prior to the new branch error are completed. If so, the control unit cancels, in step S6, all the failed speculative instructions erroneously issued in response to the second branch error and the resources thereof, and thereafter starts issuing instructions in the correct direction in step S7.

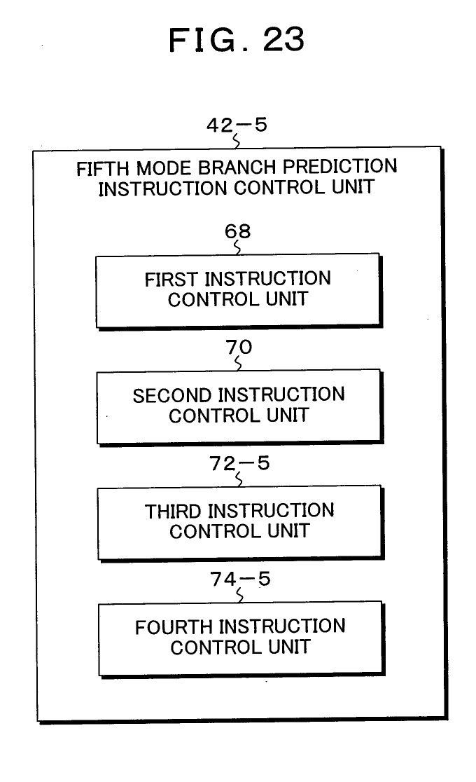

FIG. 23 is a block diagram of a fifth mode branch prediction instruction control unit 42-5, i.e., a fifth embodiment of the branch prediction instruction control unit 42 provided in the processor 10 in FIG. 4. The control unit of this embodiment is provided with the first and second instruction control units 68 and 70 and third and fourth instruction control units 72-5 and 74-5. The first and second instruction control units 68 and 70 are the same as those in the first embodiment in FIG. 7. On the other hand, the third and fourth instruction control units 72-5 and 74-5 are characterized in that they handle the instruction control if a second branch error is detected within the instructions issued in the correct direction after the detection of a first branch error, as with the third mode branch prediction instruction control unit 42-3 in FIG. 15.

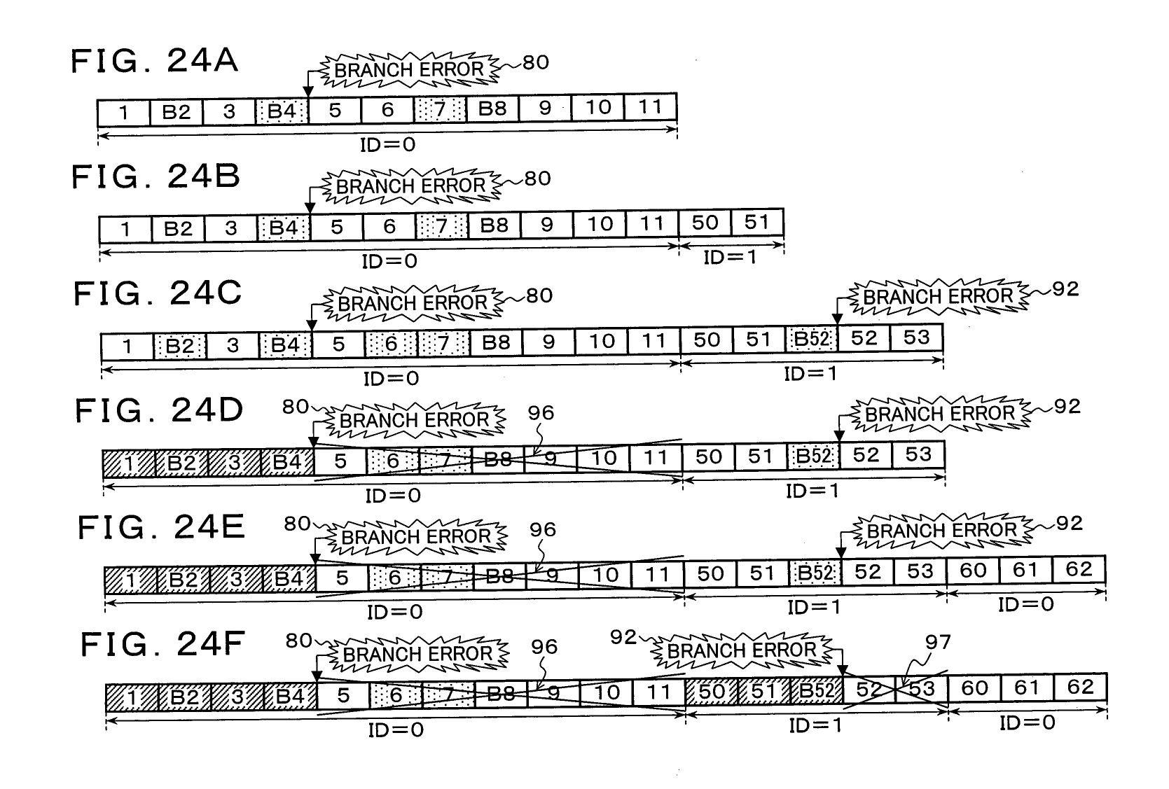

FIGS. 24A to 24F are explanatory views of the control operation carried out by the fifth mode branch prediction instruction control unit 42-5 in FIG. 23. In FIG. 24A, the first instruction control unit 68 issues instructions including the branch instructions B2, B4 and B8, and the branch error 80 is detected as a result of the execution of the branch instruction B4. Following the detection of the branch error 80, the instructions 50 and 51 are issued in the correct direction under a different ID (ID=1) subsequently to the erroneously issued instructions 5 to 11 as shown in FIG. 24B. Next, if the branch error 92 is detected as a result of the execution of the branch instruction B52, i.e., one of the instructions 50 to 53 issued in the correct direction, as shown in FIG. 24C, the third instruction control unit 72-5 in FIG. 23 waits for the completion of the instructions 1 to B4 prior to the earlier branch instruction B4 that caused the branch error 80 and thereafter proceeds with a cancellation processing 96 based on the detection of the branch error 92 while disabling the issuance of the instructions 60 to 62 and beyond in the correct direction in response to the branch error 80. Then, this control unit starts issuing the instructions 60 to 62 and beyond in the correct direction in response to the branch error 92 as shown in FIG. 24E. Next, the fourth instruction control unit 74-5 in FIG. 23 waits for the completion of all the instructions prior to the new branch instruction B52 and thereafter proceeds with a cancellation processing 97 adapted to cancel the instructions 52 and 53 issued in response to the branch error 92. Then, this control unit resumes the issuance of instructions subsequently to the instructions 60 to 62 that were issued in the correct direction in response to the branch error 92. The instruction control is compared between the fifth embodiment in FIGS. 24A to 24F and the fourth embodiment in FIGS. 20A to 20E assuming the same branch errors 80 and 92 are detected. In the fifth embodiment of FIGS. 24A to 24F, the instructions 5 to 11, i.e., the instructions erroneously issued by branch prediction in response to the branch instruction B4, are canceled through the cancellation processing 96 when all the instructions prior to the branch instruction B4 that caused the earlier branch error 80 are completed in FIG. 24D. Then, the instructions 60 to 62 are issued in the correct direction in response to the branch error 92 as shown in FIG. 24E. The instructions 60 to 62 are issued in the correct direction at an earlier timing than in the embodiment of FIGS. 20A to 20E. This provides the fifth embodiment in FIGS. 24A to 24F with an improved instruction processing performance. It is to be noted that two IDs are used as an example for the instruction control in FIGS. 24A to 24F. However, if three IDs are used, the control unit may issue instructions without any wait until all the IDs are exhausted and wait for the release of an ID after the ID exhaustion. That is, the control unit does not disable the issuance of the instructions in the correct direction in response to the branch error 92 in FIG. 24D. In this stage, instead, the control unit starts issuing the instructions 60 and 61 in the correct direction under ID=2.

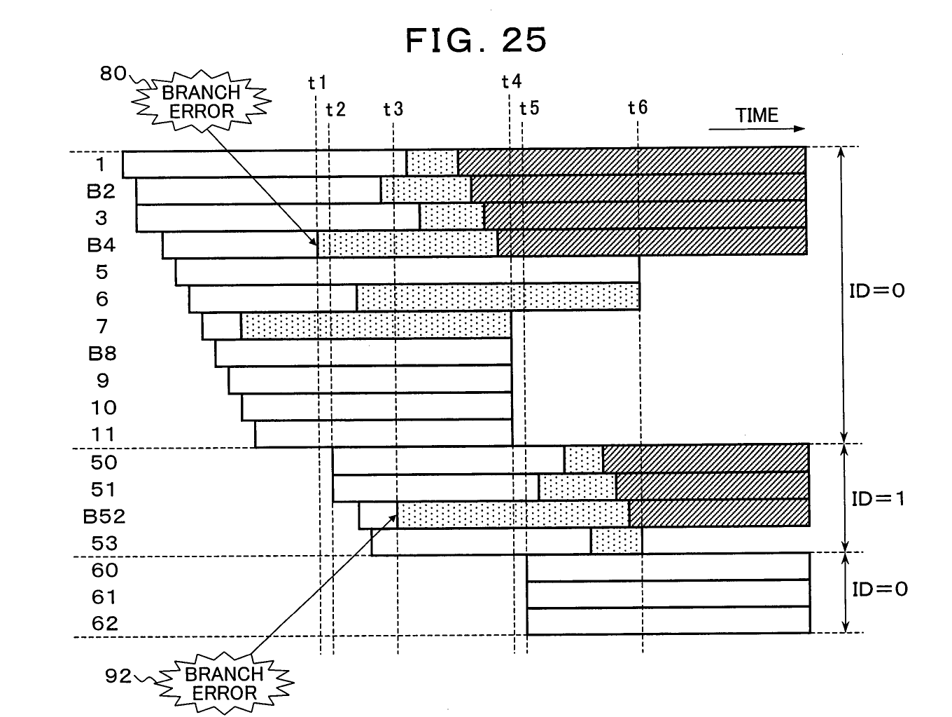

FIG. 25 is a timing chart of the instruction control corresponding to FIGS. 24A to 24F. In FIG. 25, after the detection of the branch error 80 at the time t1 as a result of the execution of the branch instruction B4, the issuance of the instructions 50 to 53 in the correct direction begins under a different ID (ID=1) at the time t2. Then, after the detection of the branch error 92 as a result of the execution of the branch instruction B52, i.e., one of the instructions 50 to 53 issued in the correct direction, the instructions 5 to 11 erroneously issued by branch prediction in response to the branch instruction B4 are canceled at the time t4 when all the instructions, prior to the branch instruction B4 that caused the first branch error 80, are completed. Next, the issuance of the instructions 60 to 62 in the correct direction in response to the branch error 92 begins at the time t5 under ID=1, the ID that has been released. Then, when all the instructions, prior to the branch instruction 52 that caused the branch error 92, are completed, the instructions 52 and 53, erroneously issued by branch prediction in response to the branch instruction B52, are canceled. The timing chart of the fifth embodiment in FIG. 25 is compared with that of the fourth embodiment in FIG. 21. The comparison shows that the instructions 60 to 62 are issued in the correct direction in response to the branch error 92 at an earlier timing in the fifth embodiment of FIG. 25. As a result, the instruction processing performance is enhanced.

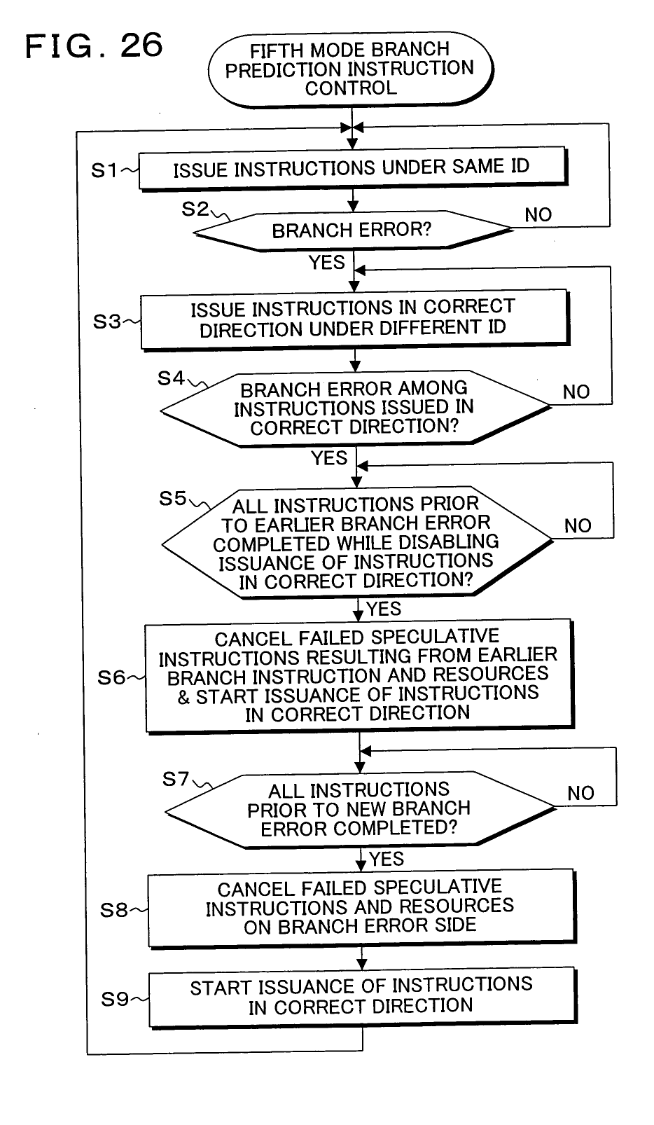

FIG. 26 is a flowchart of the instruction control conducted by the fifth mode branch prediction instruction control unit 42-5 in FIG. 23. In FIG. 26, the control unit issues instructions under the same ID in step S1. If a branch error is detected as a result of the execution of the branch instruction in step S2, the control unit issues, in step S3, instructions in the correct direction under a different ID subsequently to the erroneously issued instructions. These processings in steps S1 to S3 are handled by the first and second instruction control units 68 and 70 in FIG. 23. Next, if a second branch error is detected in step S4 as a result of the execution of the branch instruction, i.e., one of the instructions that are issued in the correct direction by the third instruction control unit 72-5, the processing proceeds to step S5. When the control unit 72-5 detects the completion of all the instructions prior to the earlier branch error in step 5 while disabling the issuance of instructions in the correct direction, the processing proceeds to step S6. The control unit 72-5 cancels the instructions erroneously issued in response to the earlier branch instruction in step S6 first and thereafter enables the issuance of instructions to start issuing instructions in the correct direction in response to the new branch error. Next, the fourth instruction control unit 74-5 determines in step S7 whether the instructions prior to the new branch error are completed. If so, the control unit 74-5 cancels the instructions erroneously issued prior to the detection of the new branch error in step S8 and starts issuing instructions in the correct direction in step S9.

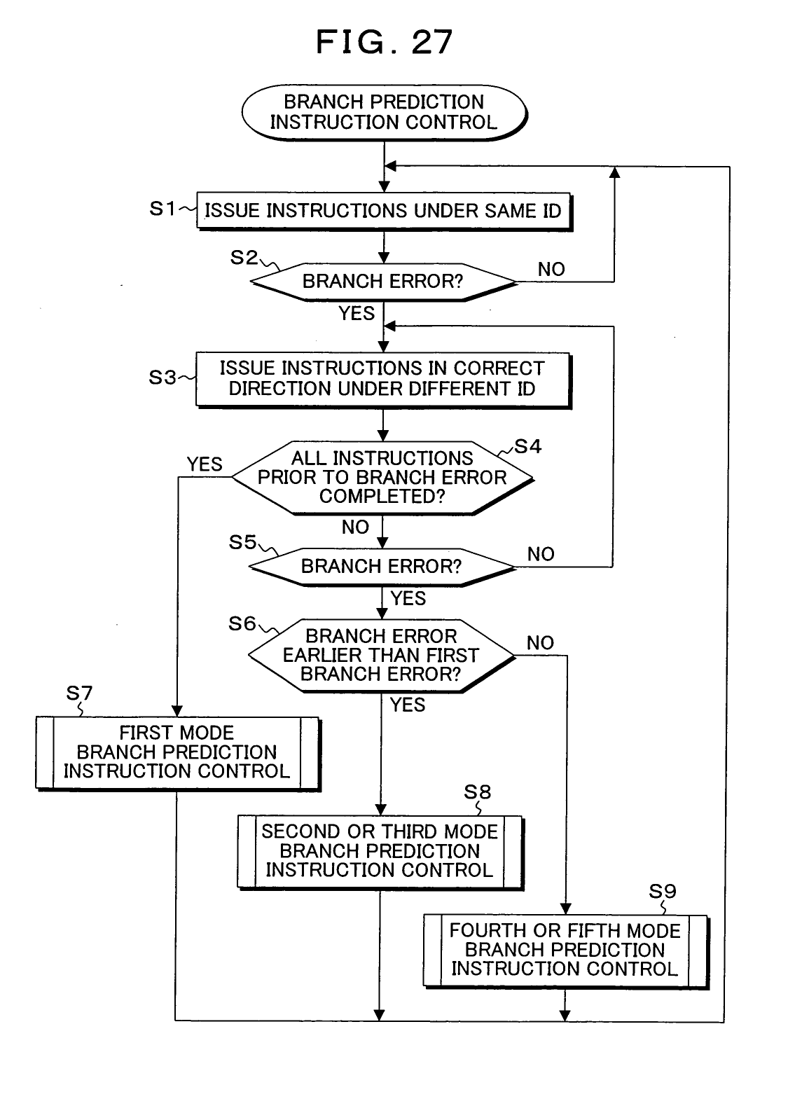

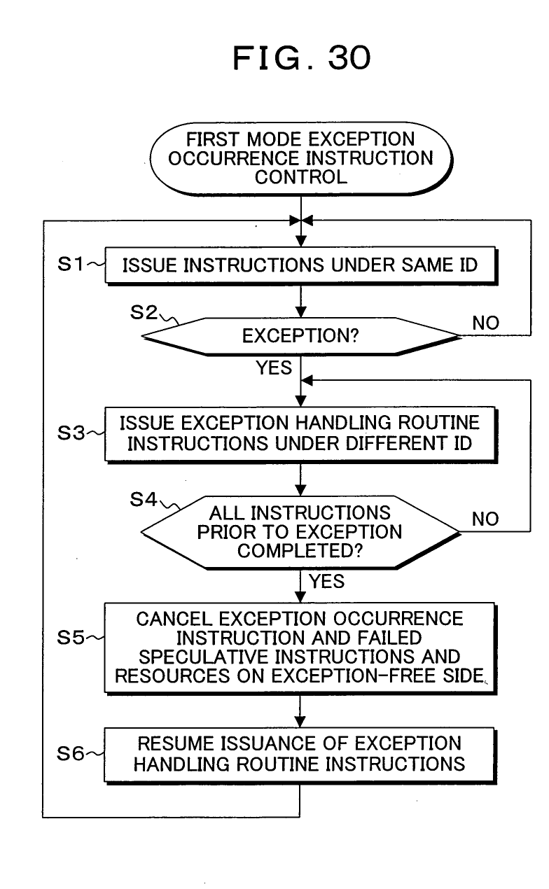

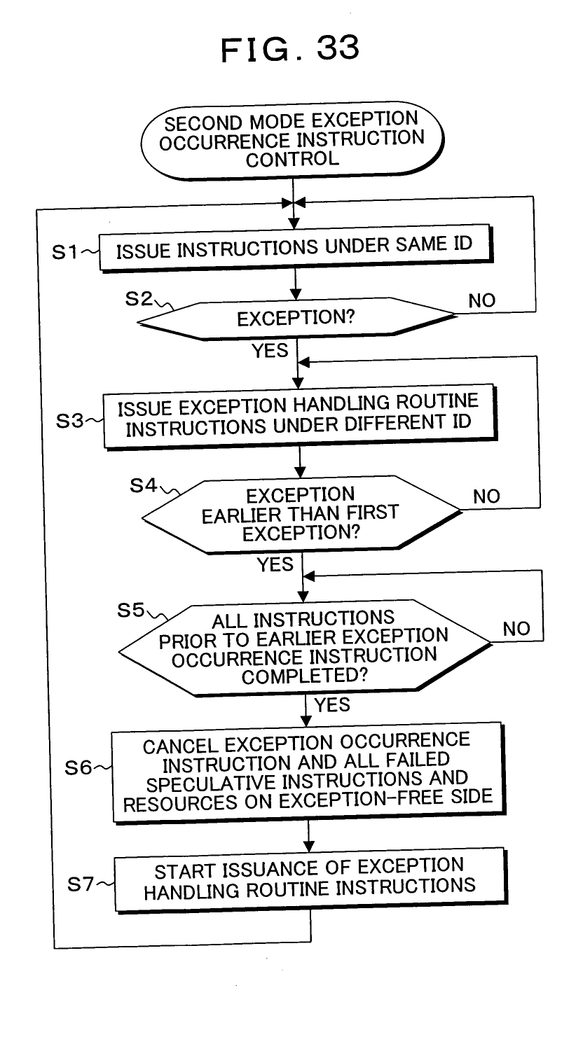

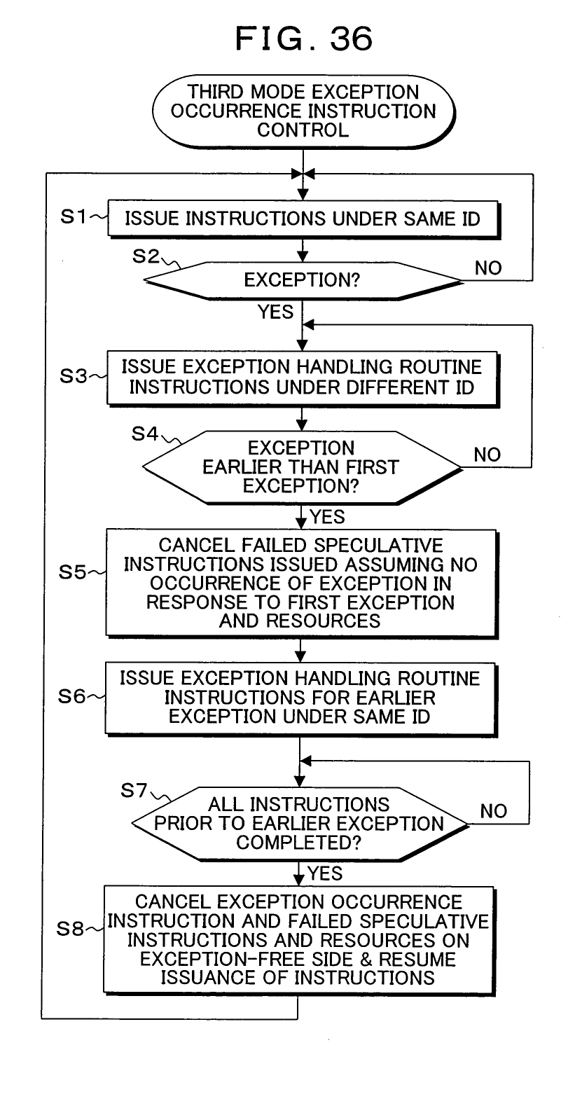

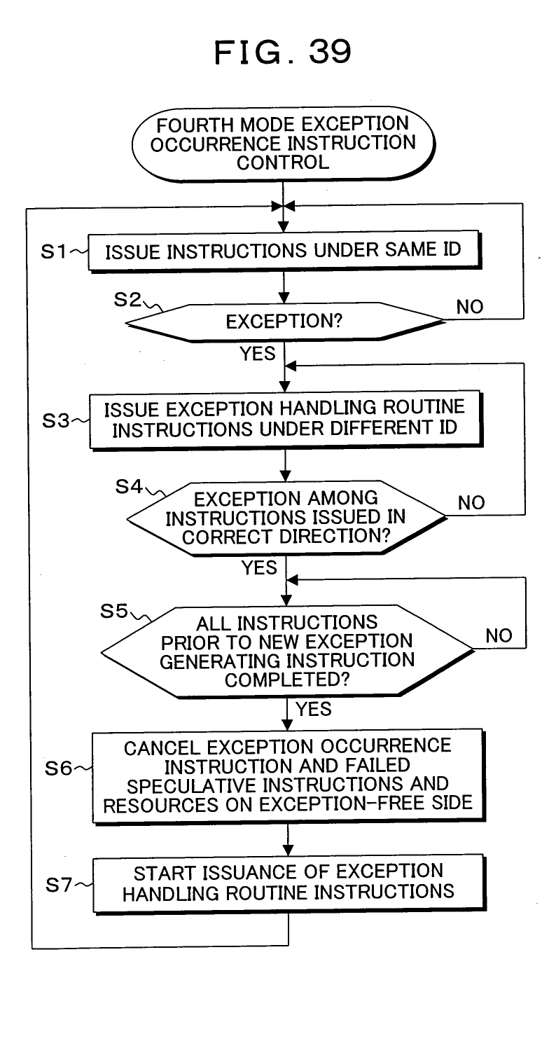

FIG. 27 is a flowchart of the branch prediction instruction control unit 42 provided in the processor 10 of FIG. 4 that brings together the first to fifth mode branch prediction instruction control described from FIGS. 7 to 25. In FIG. 27, the first and second instruction control units 68 and 70 handle the processings in steps S1 to S3. In step S1, instructions are issued under the same ID. If a branch error is detected in the in step S2 as a result of the execution of a branch instruction, instructions are issued in the correct direction under a different ID subsequently to the erroneously issued instructions in step S3. Next, it is determined in step S4 whether all the instructions prior to the branch error are completed. If so, the processing proceeds to step S7 to carry out the first mode branch prediction instruction control. The processings executed in step S7 by the first mode branch prediction instruction control are those shown in steps S5 and S6 of FIG. 30. If the instructions prior to the branch error are not completed in step S4, it is determined in step S5 whether a second branch error occurs. If the second branch error is detected, it is determined in step S6 whether the second branch error is earlier than the first one. If so, the processing proceeds to step S8 to carry out the second or third mode branch prediction instruction control. The processings in steps S5 to S7 of FIG. 33 are executed by the second mode branch prediction instruction control in step S8, whereas those in steps S5 to S8 of FIG. 36 are executed by the third mode branch prediction instruction control in step S8. On the other hand, if the second branch error is not earlier than the first one in step S6, this means that the error is a new one resulting from the execution of the branch instruction, i.e., one of the instructions issued in the correct direction in response to the branch error in step S2. Therefore, the processing proceeds to step S9 to carry out the fourth or fifth mode branch prediction instruction control. The processings in steps S5 to S7 of FIG. 39 are executed by the fourth mode branch prediction instruction control in step S9, whereas those in steps S5 to S9 of FIG. 26 are executed by the fifth mode branch prediction instruction control in step S9.

As described above, any of the first to fifth modes may be used alone in the branch prediction instruction control according to the present invention. Alternatively, the first mode may be used in combination with either of the second and third modes and either of the fourth and fifth modes.

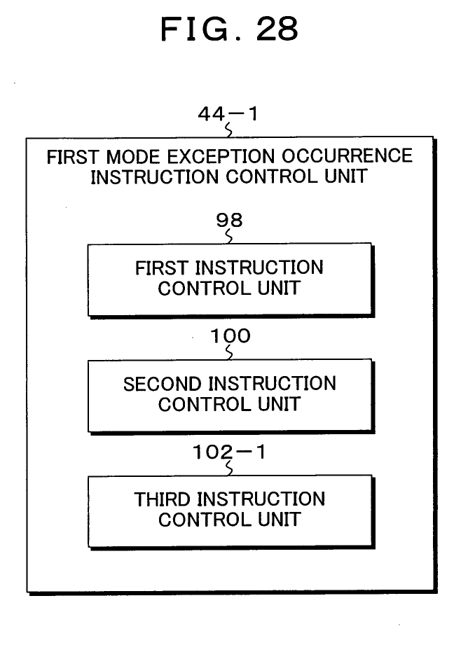

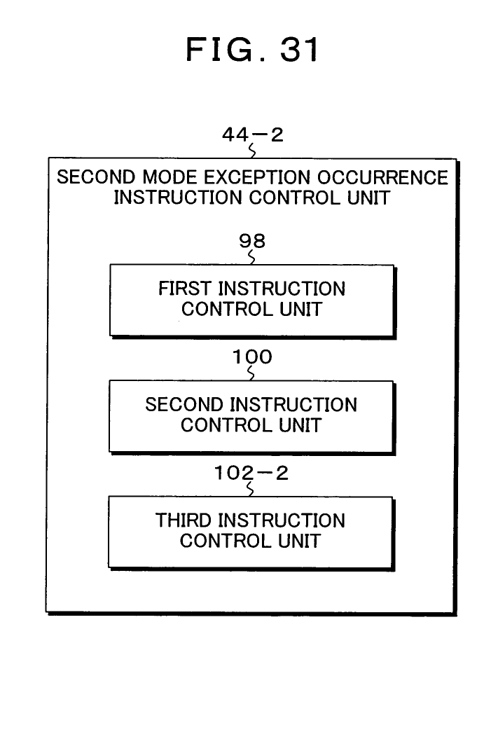

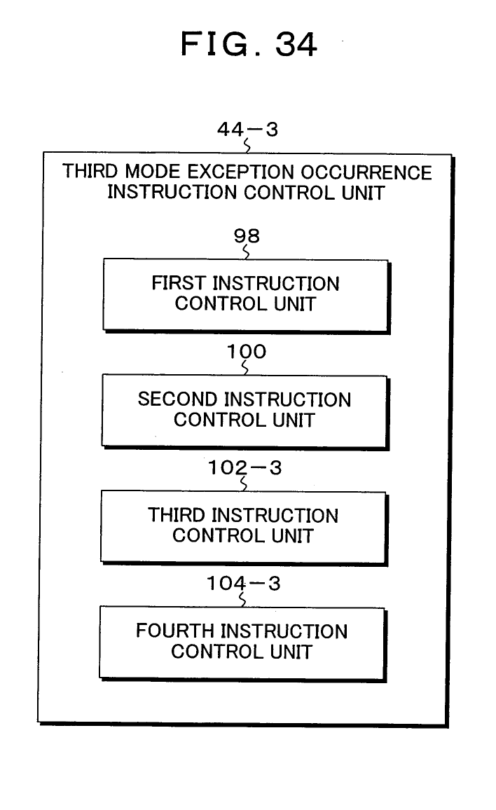

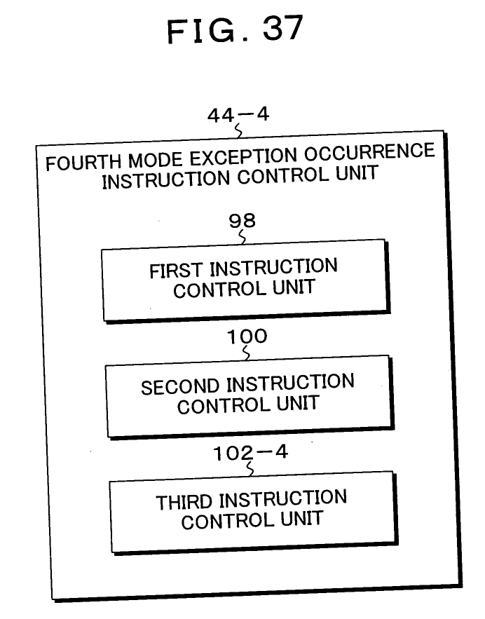

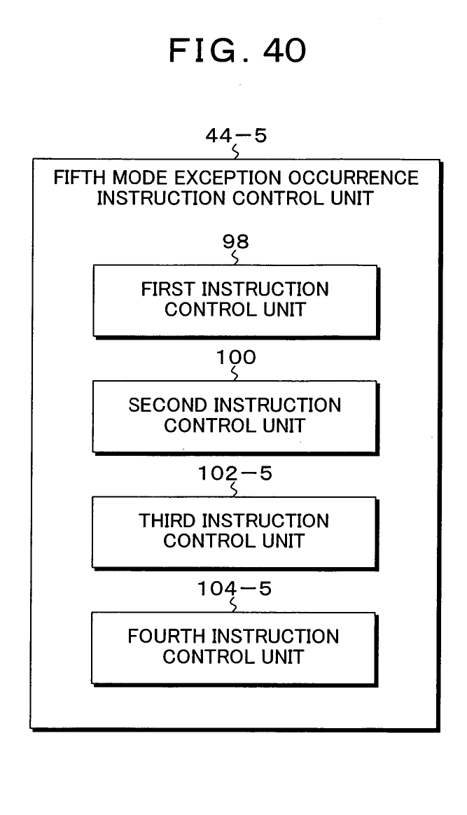

Description will be given next of the exception occurrence instruction control unit 44 provided in the processor 10 of FIG. 4. Five embodiments of the exception occurrence instruction control unit 44 are available, namely, a first mode exception occurrence instruction control unit 44-1 in FIG. 28, a second mode exception occurrence instruction control unit 44-2 in FIG. 31, a third mode exception occurrence instruction control unit 44-3 in FIG. 34, a fourth mode exception occurrence instruction control unit 44-4 in FIG. 37 and a fifth mode exception occurrence instruction control unit 44-5 in FIG. 40. These first to fifth mode exception occurrence instruction control units 44-1 to 44-5 correspond respectively to the specific embodiments of the branch prediction instruction control unit 42 described earlier, i.e., the first to fifth mode branch prediction instruction control units 42-1 to 42-5, if the detection of a branch error in the processings is replaced by the occurrence of an exception. In the case of a branch error, the failed speculative instructions, subsequent to the branch instruction that caused the branch error, are canceled. The exception occurrence instruction control differs therefrom in that the failed speculative instructions, including the exception occurrence instruction, are canceled.

The occurrence of an exception can be briefly described as follows. The first mode exception occurrence instruction control unit 44-1 in FIG. 28 has first, second and third instruction control units 98, 100 and 102-1.

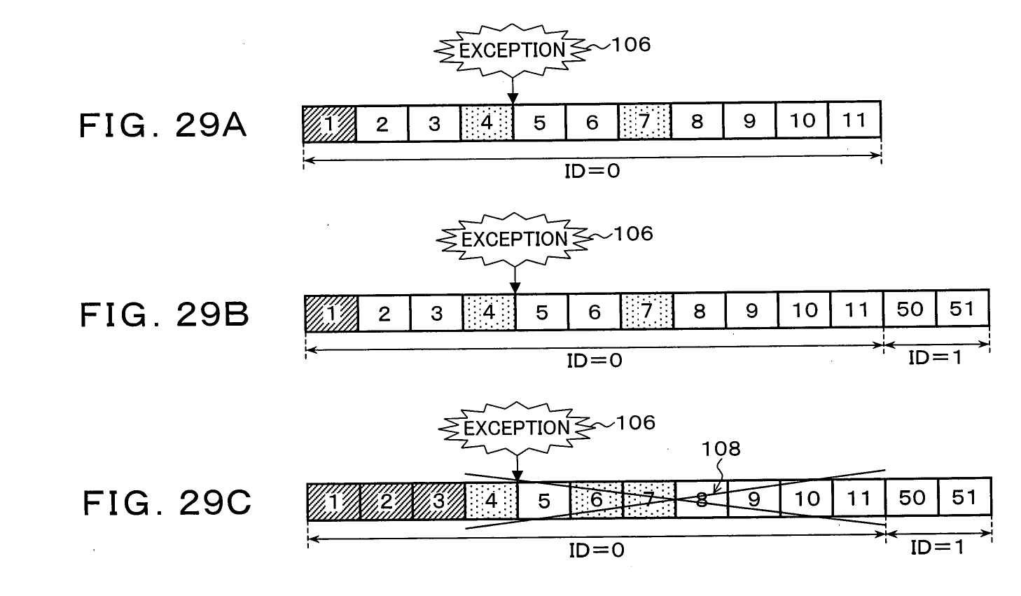

FIGS. 29A to 29C illustrate the instruction control operation carried out by the first mode exception occurrence instruction control unit 44-1.

If an exception 105 occurs in the instruction 4, i.e., one of the instructions 1 to 10 issued under ID=0 in FIG. 29A, the control unit issues the exception handling routine instructions 50 and 51 under a different ID (ID=1) subsequently to the instructions 5 to 11 that were issued assuming no occurrence of an exception. Next, at the completion of the instructions 1 to 3 prior to the exception occurrence instruction 4, the control unit proceeds with a cancellation processing 108 adapted to cancel the failed speculative instructions 5 to 11 first and thereafter resumes the issuance of the exception handling routine instructions as shown in FIG. 29C.

FIG. 30 is a flowchart of the first mode exception occurrence instruction control. The control unit issues instructions under the same ID in step S1. If the occurrence of an exception is detected in step S2 as a result of the execution of an instruction, the control unit issues exception handling routine instructions under a different ID subsequently to the failed speculative instructions in step S3. Upon detecting the completion of all the instructions prior to the exception occurrence instruction in step S4, the control unit cancels the failed speculative instructions issued assuming no occurrence of an exception and the resources thereof in step S5 and thereafter resumes the issuance of the exception handling routine instructions in step S6.

FIG. 31 is a block diagram of the second mode exception occurrence instruction control unit 44-2. This control unit is provided with the first and second instruction control units 98 and 100 and a third instruction control unit 102-2.

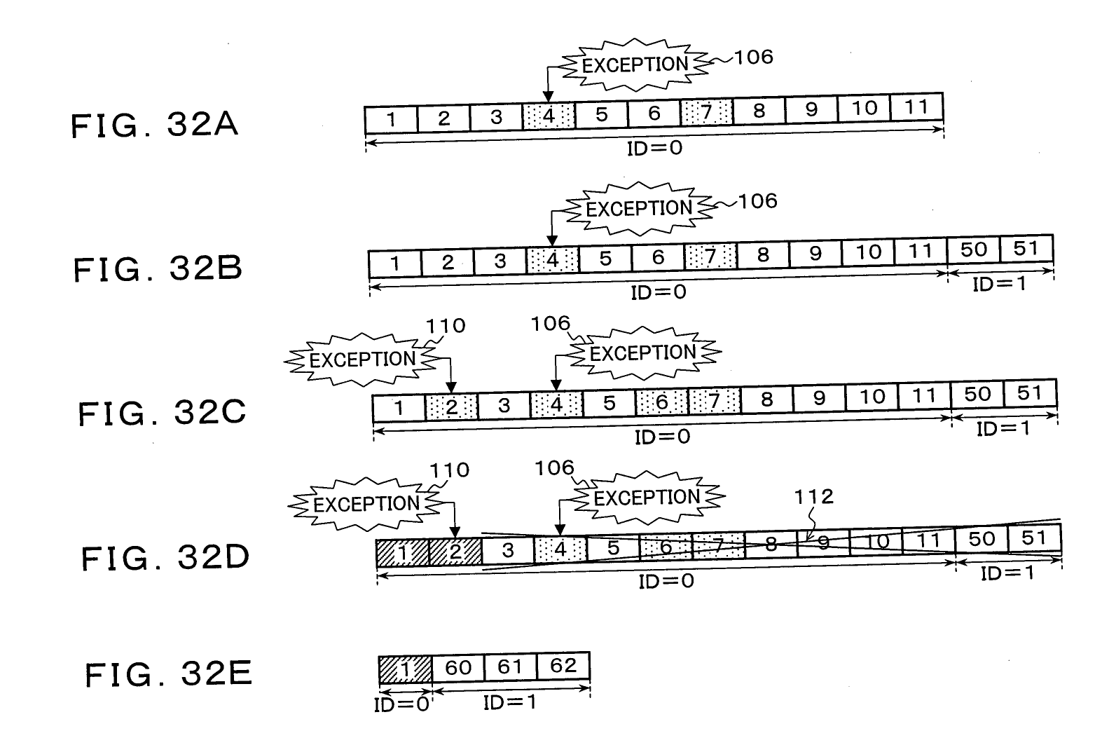

FIGS. 32A to 32E illustrate the instruction control operation carried out by the second mode exception occurrence instruction control unit 44-2. If an exception 106 occurs in the instruction 4, i.e., one of the instructions 1 to 11 issued under ID=0 in FIG. 32A, the control unit issues the exception handling routine instructions 50 and 51 under a different ID (ID=1) subsequently to the failed speculative instructions 5 to 11 that were issued assuming no occurrence of an exception as shown in FIG. 32B. Next, if an exception 110 occurs as a result of the execution of the instruction 2 that is earlier than the instruction 4 that caused the exception 106, as shown in FIG. 32C, the control unit proceeds with a cancellation processing 112 adapted to cancel the subsequent instructions 2 to 51 including the instruction 2 that caused the exception 110 at the completion of the instruction 1 prior to the exception 110 caused by the earlier instruction 2 as shown in FIG. 32D and thereafter starts the issuance of the exception handling routine instructions 60 to 62 as shown in FIG. 32E.

FIG. 33 is a flowchart of the second mode exception occurrence instruction control. In FIG. 33, the control unit issues instructions under the same ID in step S1. If the occurrence of an exception is detected in step S2 as a result of the execution of an instruction, the control unit issues exception handling routine instructions in step S3 under a different ID subsequently to the instructions that were erroneously issued assuming no occurrence of an exception. Next, the control unit checks in step S4 whether an exception occurred in an instruction earlier than that which caused the first exception. If so, the control unit determines in step S5 whether all the instructions prior to the earlier exception occurrence instruction are completed. If so, the control unit cancels all the failed speculative instructions including the earlier exception occurrence instruction and the resources thereof in step S6 and thereafter starts issuing the exception handling routine instructions in step S7.

FIG. 34 is a block diagram of the third mode exception occurrence instruction control unit 44-3. This control unit is provided with the first and second instruction control units 98 and 100 and third and fourth instruction control units 102-3 and 104-3.

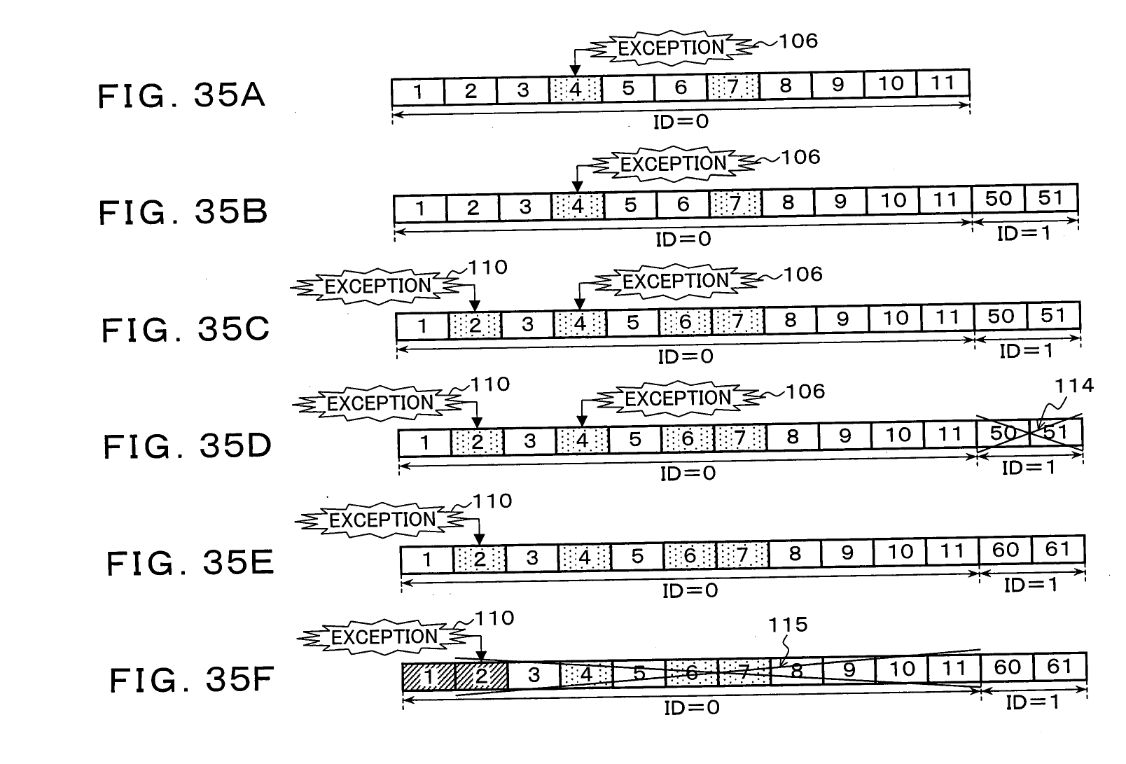

FIGS. 35A to 35F are explanatory views of the instruction control conducted by the third mode exception occurrence instruction control unit 44-3 in FIG. 34. If an exception 106 occurs as a result of the execution of the instruction 4, i.e., one of the instructions 1 to 11 that were issued under ID=0 as shown in FIG. 35A, the control unit issues the exception handling routine instructions 50 and 51 under a different ID (ID=1) subsequently to the failed speculative instructions 5 to 11 that were issued in response to the instruction 4 assuming no occurrence of an exception, as shown in FIG. 35B. Next, if the exception 110 occurs as a result of the execution of the instruction 2 that is earlier than the instruction 4 that caused the exception 106, as shown in FIG. 35C, the control unit proceeds with a cancellation processing 114 adapted to cancel the instructions 50 and 51, i.e., the instructions issued as the exception handling routine in response to the occurrence of the exception 106, as shown in FIG. 35D. Then, the control unit issues the exception handling routine instructions 60 and 61 in response to the exception 110 in FIG. 35E. In FIG. 35F, after the instruction 1, i.e., the instruction earlier than the instruction 2 that caused the earlier exception 110, is completed, the control unit proceeds with a cancellation processing 116 adapted to cancel the failed speculative instructions 3 to 11 including the instruction 2 that caused the exception 110 and thereafter resumes the issuance of instructions subsequently to the exception handling routine instructions 60 and 61 issued in response to the exception 110.

FIG. 36 is a flowchart of the third mode exception occurrence instruction control. In FIG. 36, the control unit issues instructions under the same ID in step S1. If an exception occurs in one of the instructions in step S2, the control unit issues exception handling routine instructions in step S3 under a different ID subsequently to the instructions that were erroneously issued after the exception occurrence instruction assuming no occurrence of an exception. Next, the control unit determines in step S4 whether an exception occurred in an instruction earlier than that which caused the first exception. If so, the control unit cancels the failed speculative instructions issued as the exception handling routine in response to the first exception and the resources thereof in step S5 and thereafter issues the exception handling routine instructions in response to the earlier exception under the same ID as in step S3. Next, upon detecting the completion of all the instructions prior to the earlier exception occurrence instruction in step S7, the control unit cancels the failed speculative instructions including the earlier exception occurrence instruction that were issued assuming no occurrence of an exception and the resources thereof and thereafter resumes the issuance of the exception handling routine instructions in step S8.

FIG. 37 is a block diagram of the fourth mode exception occurrence instruction control unit 44-4. This control unit is provided with the first and second instruction control units 98 and 100 and a third instruction control unit 102-4.

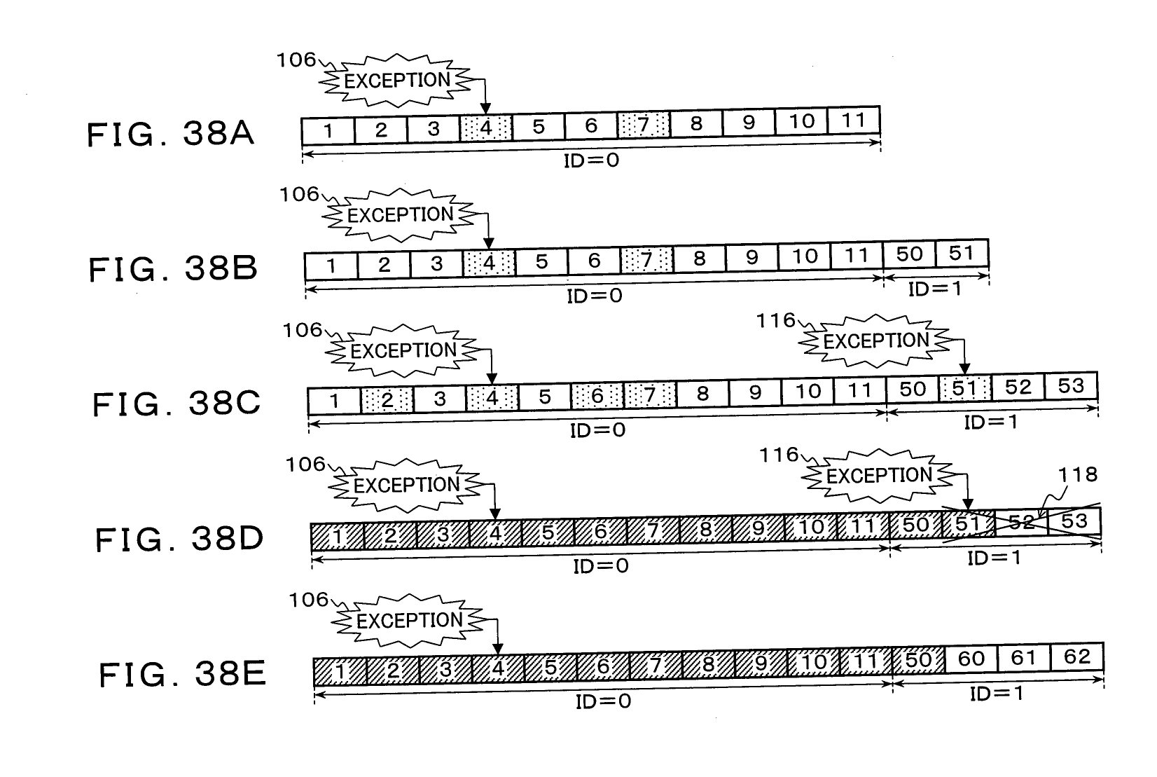

FIGS. 38A to 38E are explanatory views of the instruction control conducted by the fourth mode exception occurrence instruction control unit 44-4. If the exception 106 occurs as a result of the execution of the instruction 4 following the issuance of the instructions 1 to 11 as shown in FIG. 38A, the control unit issues the exception handling routine instructions 50 and 51 under a different ID (ID=1) in response to the exception 106 subsequently to the failed speculative instructions 5 to 11 that were issued assuming no occurrence of an exception as shown in FIG. 38B. Next, if a second exception 116 occurs as a result of the execution of the instruction 51, i.e., one of the instructions 50 to 53 that were issued as the exception handling routine instructions in response to the exception 106, as shown in FIG. 38C, the control unit proceeds with a cancellation processing 118 adapted to cancel the failed speculative instructions 52 and 53 that were issued assuming no occurrence of an exception in the instructions 50 and 51, of which the instruction 51 caused the exception 116, as shown in FIG. 38D. Then, the control unit resumes the issuance of the exception handling routine instructions 60 to 62 and beyond in response to the exception 116, as shown in FIG. 38E.

FIG. 39 is a flowchart of the fourth mode exception occurrence instruction control. In FIG. 39, the control unit issues instructions under the same ID in step S1. If the occurrence of an exception is detected in step S2 as a result of the execution of an instruction, the control unit issues exception handling routine instructions in step S3 under a different ID subsequently to the instructions that were erroneously issued assuming no occurrence of an exception. Next if the occurrence of a second exception is detected in step S4 as a result of the execution of one of the instructions issued as the exception handling routine instructions, the control unit determines in step S5 whether all the instructions prior to the new exception are completed. If so, the control unit proceeds to step S6 to cancel the instruction that caused the new exception, all the failed speculative instructions subsequent to the exception occurrence instruction and the resources thereof and thereafter resumes the issuance of the exception handling routine instructions in response to the new exception in step S7.

FIG. 40 is a block diagram of the fifth mode exception occurrence instruction control unit 44-5. This control unit is provided with the first and second instruction control units 98 and 100 and third and fourth instruction control unit 102-5 and 104-5.

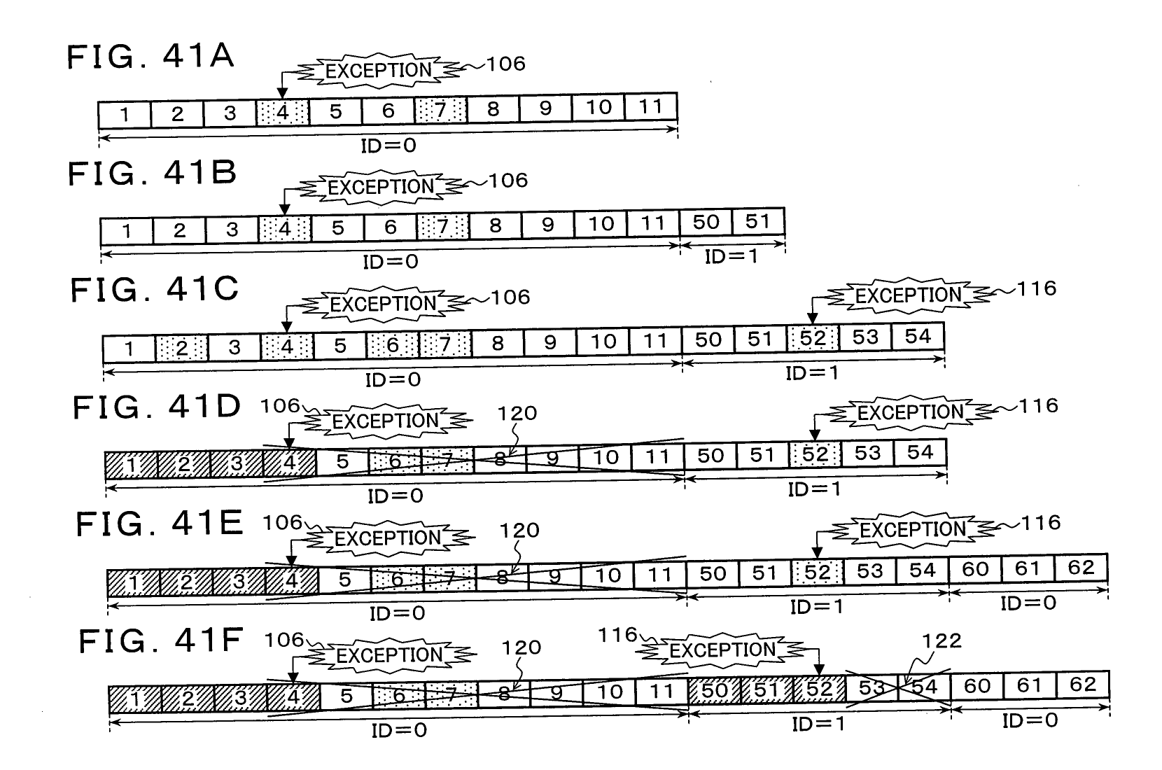

FIGS. 41A to 41F are explanatory views of the instruction control conducted by the fifth mode exception occurrence instruction control unit 44-5.

If the exception 106 occurs in the instruction 4, i.e., one of the instructions 1 to 11 issued under ID=0, as shown in FIG. 41A, the control unit issues the exception handling routine instructions 50 and 51 in response to the exception 106 under a different ID (ID=1) subsequently to the failed speculative instructions 5 to 11 that were issued after the instruction 4 assuming no occurrence of an exception as shown in FIG. 41B. Next, if the second exception 116 occurs as a result of the execution of the instruction 52, i.e., one of the instructions 50 to 53 that were issued as the exception handling routine instructions as shown in FIG. 41C, the control unit waits for the completion of all the instructions 1 to 3 prior to the instruction 4 that caused the earlier exception 106 and thereafter proceeds with a cancellation processing 120 adapted to cancel the failed speculative instructions 5 to 11 following the exception occurrence instruction 4, as shown in FIG. 41D. Next, the control unit starts issuing the exception handling routine instructions 60 to 62, as shown in FIG. 41E, subsequently to the instructions 53 and 54, i.e., the failed speculative instructions in response to the second and new exception 116, in response to the exception 116 under ID=0 that was released by the cancellation processing 120. In the end, the control unit waits for the completion of all the instructions 50 and 51 prior to the instruction 52 that caused the new exception 116 and thereafter proceeds with a cancellation processing 122 adapted to cancel the instruction 52 that caused the exception 116 and the subsequent failed speculative instructions 53 and 54, followed by the resumption of the issuance of the exception handling routine instructions 60 to 62 as shown in FIG. 41F. It is to be noted that two IDs are used as an example for the instruction control in FIGS. 41A to 41F. However, if three IDs are used, the control unit may issue instructions without any wait until all the IDs are exhausted and wait for the release of an ID after the ID exhaustion. That is, the control unit does not disable the issuance of the instructions in the correct direction in response to the exception 116 in FIG. 41D. In this stage, instead, the control unit starts issuing the instructions 60 to 62 in the correct direction under ID=2.

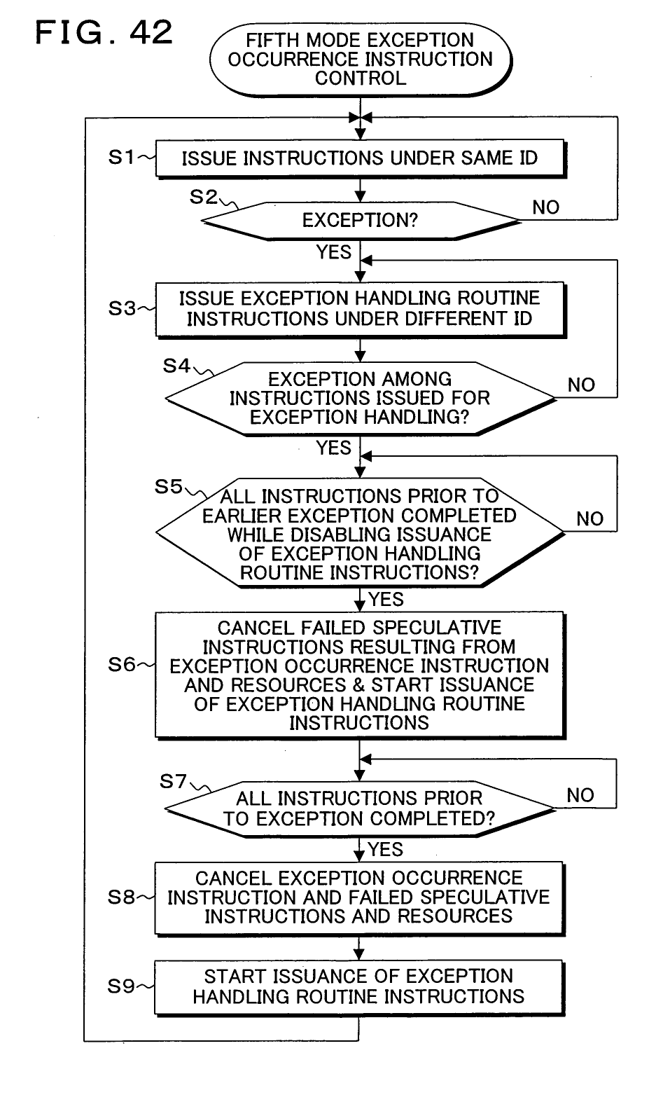

FIG. 42 is a flowchart of the fifth mode exception occurrence instruction control. In FIG. 42, the control unit issues instructions under the same ID in step S1. If an exception occurs in step S2 as a result of the execution of one of the instructions, the control unit issues exception handling routine instructions in step S3 under a different ID subsequently to the failed speculative instructions following the exception occurrence instruction. Next, if an exception occurs in step S4 as a result of the execution of one of the instructions issued as the exception handling routine instructions, the control unit determines in step S5 whether all the instructions prior to the one that caused the earlier exception are completed while disabling the issuance of the exception handling routine instructions. If so, the control unit cancels the exception occurrence instruction, the subsequent failed speculative instructions and the resources thereof and thereafter starts issuing the exception handling routine instructions in response to the new exception in step S6. Next, the control unit checks in step S7 whether all the instructions prior to the one that caused the new exception are completed. If so, the control unit cancels the instruction that caused the new exception, the subsequent failed speculative instructions and the resources thereof in step S8 and thereafter resumes the issuance of the exception handling routine instructions in response to the new exception in step S9.

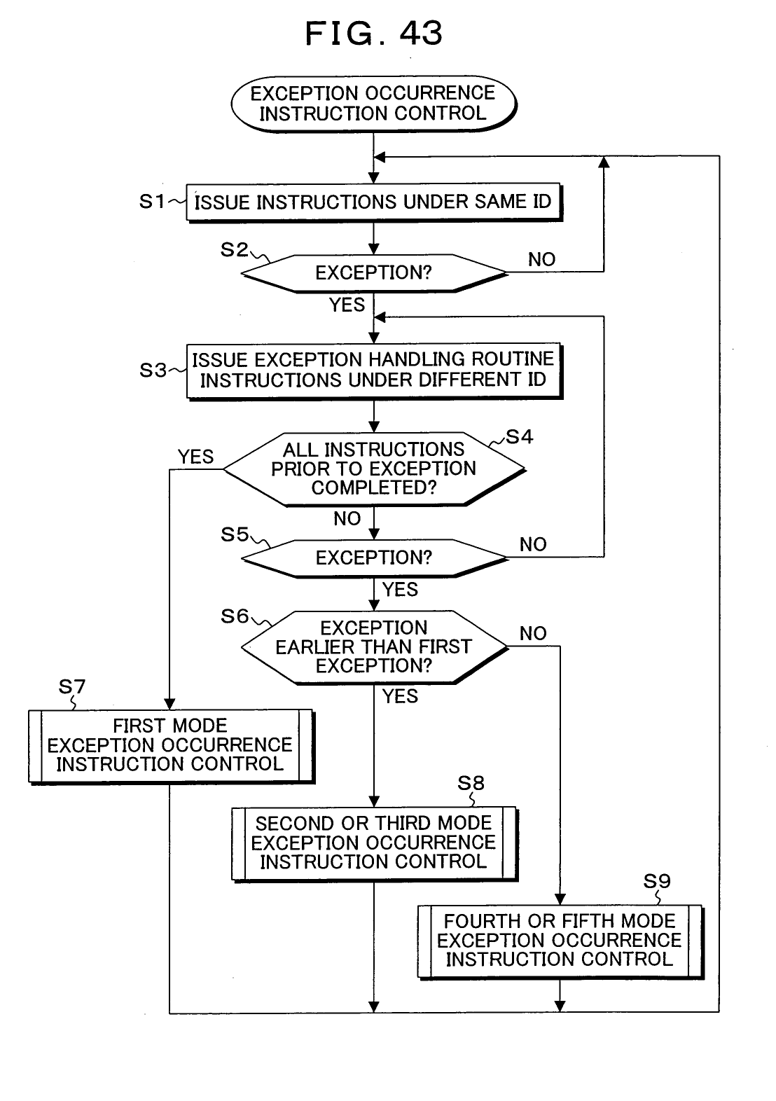

FIG. 43 is a flowchart of the exception occurrence instruction control conducted by the exception occurrence instruction control unit 44 provided in the processor 10 of FIG. 4 that brings together the first to fifth mode exception occurrence instruction control described above. In the flowchart of FIG. 43, the control unit issues instructions under the same ID in step S1. If the occurrence of an exception is detected in step S2 as a result of the execution of an instruction, the control unit issues exception handling routine instructions in step S3 under a different ID subsequently to the failed speculative instructions. Next, the control unit checks in step S4 whether all the instructions prior to the one that caused the exception are completed. If so, the control unit carries out the first mode exception occurrence instruction control in step S7. The processings executed by this instruction control are those shown in steps S5 and S6 of FIG. 30. If the instructions prior to the exception are not completed in step S4, the control unit checks in step S5 whether a second exception occurs. If the second exception occurs, the control unit proceeds to step S6 to determine whether the exception is earlier than the first exception. If so, the control unit proceeds to step S8 to carry out the second or third mode exception occurrence instruction control. In this case, the processings in steps S5 to S7 of FIG. 33 are executed by the second mode exception occurrence instruction control, whereas those in steps S5 to S8 of FIG. 36 are executed by the third mode exception occurrence instruction control. Further, if the exception is newer than the first exception, the control unit proceeds to step S9 to carry out the fourth or fifth mode exception occurrence instruction control. The processings in steps S5 to S7 of FIG. 39 are executed by the fourth mode exception occurrence instruction control, whereas those in steps S5 to S9 of FIG. 42 are executed by the fifth mode exception occurrence instruction control.

It is to be noted that while the above embodiments take branch instructions and exceptions resulting from the execution of instructions as examples of speculatively executed instructions, the present invention may be applied to other appropriate speculative instructions.

The present invention is not limited to the above embodiments. The present invention includes appropriate modifications without departing from the objects and advantages of the invention, and is not limited by the numerical values described in the embodiments.

### INDUSTRIAL APPLICABILITY

As set forth hereinabove, the present invention allows the realization of fast processings with only a few hardware resources, i.e., the processings adapted to cancel the failed speculative instructions that were erroneously issued and resume the issuance of instructions in the correct direction in the event of a branch error during the speculative execution of instructions based on branch prediction. This significantly contributes to the performance enhancement particularly in the case of the processor operating at radio frequencies.

Similarly, the present invention allows the realization of fast processings with only a few hardware resources, i.e., the processings adapted to cancel the failed speculative instructions that were issued assuming no occurrence of an exception and issue exception handling routine instructions in the event of an exception. This also significantly contributes to the performance enhancement in the case of the processor operating at radio frequencies.

1. A processor comprising:
a first instruction control unit operable to issue instructions including a branch instruction with a first identifier attached thereto and speculatively execute the instructions by branch prediction;
a second instruction control unit operable to issue instructions in the correct direction with a second identifier attached thereto subsequent to the erroneously issued instructions upon the detection of a branch error; and
a third instruction control unit operable, after the completion of all the instructions prior to the branch instruction, to cancel the instructions erroneously issued by branch prediction and start issuing instructions in the correct direction.

2. A processor comprising:
a first instruction control unit operable to issue instructions including a branch instruction with a first identifier attached thereto and speculatively execute the instructions by branch prediction;
a second instruction control unit operable to issue instructions in the correct direction with a second identifier attached thereto subsequent to the erroneously issued instructions upon the detection of a first branch error; and
a third instruction control unit operable, in the event of the detection of a second branch error in an earlier branch instruction after the issuance of instructions in the correct direction following the detection of the first branch error, to cancel in response to the completion of all the instructions prior to the earlier branch instruction all the subsequent instructions and start issuing instructions in the correct direction.

3. A processor comprising:
a first instruction control unit operable to issue instructions including a branch instruction with a first identifier attached thereto and speculatively execute the instructions by branch prediction;
a second instruction control unit operable to issue instructions in the correct direction with a second identifier attached thereto subsequent to the erroneously issued instructions upon the detection of a first branch error;
a third instruction control unit operable, in the event of the detection of a second branch error in an earlier branch instruction after the issuance of instructions in the correct direction following the detection of the first branch error, to cancel the instructions issued in the presumably correct direction as a result of the detection of the first branch error and thereafter start issuing instructions in the correct direction determined based on the detection of the second branch error; and
a fourth instruction control unit operable, after the issuance of instructions in the correct direction as a result of the detection of the second branch error, to cancel in response to the completion of all the instructions prior to the earlier branch instruction the instructions that were erroneously issued based on the second branch prediction, and resume issuing instructions in the correct direction.

4. A processor comprising:
a first instruction control unit operable to issue instructions including a branch instruction with a first identifier attached thereto and speculatively execute the instructions by branch prediction;
a second instruction control unit operable to issue instructions in the correct direction with a second identifier attached thereto subsequent to the erroneously issued instructions upon the detection of a first branch error; and
a third instruction control unit operable, in the event of the detection of a second branch error in a new branch instruction which is one of the instructions issued in the presumably correct direction after the start of the issuance of instructions in the correct direction following the detection of the first branch error, to cancel in response to the completion of all the instructions prior to the new branch instruction all the subsequent instructions and start issuing instructions in the correct direction.

5. A processor comprising:
a first instruction control unit operable to issue instructions including a branch instruction with a first identifier attached thereto and speculatively execute the instructions by branch prediction;
a second instruction control unit operable to issue instructions in the correct direction with a second identifier attached thereto subsequent to the erroneously issued instructions upon the detection of a first branch error;
a third instruction control unit operable, in the event of the detection of a second branch error in a new branch instruction which is one of the instructions issued in the presumably correct direction after the start of the issuance of instructions in the correct direction following the detection of the first branch error, to cancel, in response to the completion of all the instructions prior to the earlier branch instruction that caused the first branch error while disabling the issuance of instructions in the correct direction, the instructions that were erroneously issued based on the earlier branch instruction, and enable the issuance of instructions to start issuing instructions in the correct direction; and
a fourth instruction control unit operable, after the start of the issuance of instructions in the correct direction determined based on the detection of the second branch error, to cancel in response to the completion of all the instructions prior to the new branch instruction the instructions that were erroneously issued as a result of the detection of the first branch error, and resume issuing instructions in the correct direction based on the second branch error.

6. The processor of any one of claim 1, further comprising:
a rename map having, for each of entries referenced by register numbers used by instructions, an address storage area of a reorder buffer used for renaming and a plurality of valid flag areas corresponding to a plurality of identifiers attached to the instructions; and
a renaming processing unit operable, when renaming the registers used by the instructions with the reorder buffer, to store the address of the reorder buffer used for the renaming in the entry of the rename map referenced by the register number, turn on the valid flag corresponding to the identifier attached to the instructions, turn off the valid flag of the rename map corresponding to the identifier attached to the erroneously issued instructions in the event of the detection of a branch error, and turn on the valid flag of the rename map corresponding to the identifier attached to the instructions issued in the correct direction, wherein
the instructions issued in the correct direction as a result of the detection of a branch error are prevented from using rename information derived from the erroneously issued instructions.

7. An instruction control method for a processor, the method comprising:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a branch error; and
a third step, after the completion of all the instructions prior to the branch instruction, of canceling the instructions erroneously issued by branch prediction and starting issuing instructions in the correct direction.

8. An instruction control method for a processor, the method comprising:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error; and
a third step, in the event of the detection of a second branch error in an earlier branch instruction after the issuance of instructions in the correct direction following the detection of the first branch error, of canceling in response to the completion of all the instructions prior to the earlier branch instruction all the subsequent instructions and start issuing instructions in the correct direction.

9. An instruction control method for a processor, the method comprising:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error;
a third step, in the event of the detection of a second branch error in an earlier branch instruction after the issuance of instructions in the correct direction following the detection of the first branch error, of canceling the instructions issued in the presumably correct direction as a result of the detection of the first branch error and thereafter starting issuing instructions in the correct direction determined based on the detection of the second branch error; and
a fourth step, after the issuance of instructions in the correct direction as a result of the detection of the second branch error, of canceling in response to the completion of all the instructions prior to the earlier branch instruction the instructions that were erroneously issued based on the second branch prediction, and resuming issuing instructions in the correct direction.

10. An instruction control method for a processor, the method comprising:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error; and
a third step, in the event of the detection of a second branch error in a new branch instruction which is one of the instructions issued in the presumably correct direction after the start of the issuance of instructions in the correct direction following the detection of the first branch error, of canceling in response to the completion of all the instructions prior to the new branch instruction all the subsequent instructions and starting issuing instructions in the correct direction.

11. An instruction control method for a processor, the method comprising:
a first step of issuing instructions including a branch instruction with a first identifier attached thereto and speculatively executing the instructions by branch prediction;
a second step of issuing instructions in the correct direction with a second identifier attached thereto subsequent to the erroneously issued instructions upon the detection of a first branch error;
a third step, in the event of the detection of a second branch error in a new branch instruction which is one of the instructions issued in the presumably correct direction after the start of the issuance of instructions in the correct direction following the detection of the first branch error, of canceling, in response to the completion of all the instructions prior to the earlier branch instruction that caused the first branch error while disabling the issuance of instructions in the correct direction, the instructions that were erroneously issued based on the earlier branch instruction, and enabling the issuance of instructions to start issuing instructions in the correct direction; and
a fourth step, after the start of the issuance of instructions in the correct direction determined based on the detection of the second branch error, of canceling in response to the completion of all the instructions prior to the new branch instruction the instructions that were erroneously issued as a result of the detection of the first branch error, and resuming issuing instructions in the correct direction based on the second branch error.

12. The instruction control method for a processor of any one of claim 7, wherein
in case that a rename map is disposed for each of entries referenced by register numbers used by instructions, the rename map having an address storage area of a reorder buffer used for renaming and a plurality of valid flag areas corresponding to a plurality of identifiers attached to the instructions; the method further comprising:
when the registers used by the instructions are renamed with the reorder buffer, storing the address of the reorder buffer used for the renaming in the entry of the rename map referenced by the register number, and turning on the valid flag corresponding to the identifier attached to the instructions; and
turning off the valid flag of the rename map corresponding to an identifier attached to the erroneously issued instructions in the event of the detection of a branch error, and turning on the valid flag of the rename map corresponding to another identifier attached to the instructions issued in the correct direction, whereby
the instructions issued in the correct direction as a result of the detection of a branch error are prevented from using rename information derived from the erroneously issued instructions.

13. A processor comprising:
a first instruction control unit operable to issue instructions including an exception occurrence instruction with a first identifier attached thereto and speculatively execute the instructions assuming no occurrence of an exception;
a second instruction control unit operable to issue exception handling routine instructions with a second identifier attached thereto subsequent to the instructions erroneously issued assuming no occurrence of an exception upon the detection of an exception; and
a third instruction control unit operable to cancel the exception occurrence instruction and the instructions erroneously issued assuming no occurrence of an exception and start issuing the exception handling routine instructions after the completion of all the instructions prior to the exception occurrence instruction.

14. A processor comprising:
a first instruction control unit operable to issue instructions including an exception occurrence instruction with a first identifier attached thereto and speculatively execute the instructions assuming no occurrence of an exception;
a second instruction control unit operable to issue exception handling routine instructions with a second identifier attached thereto subsequent to the instructions erroneously issued assuming no occurrence of an exception upon the detection of a first exception; and
a third instruction control unit operable, in the event of the detection of a second exception in an earlier instruction after the issuance of exception handling routine instructions in the correct direction following the detection of the first exception, to cancel the exception occurrence instruction and all the subsequent instructions in response to the completion of all the instructions prior to the earlier exception occurrence instruction, and thereafter start issuing exception handling routine instructions based on the detection of the second exception.

15. A processor comprising:
a first instruction control unit operable to issue instructions including an exception occurrence instruction with a first identifier attached thereto and speculatively execute the instructions assuming no occurrence of an exception;
a second instruction control unit operable to issue exception handling routine instructions with a second identifier attached thereto subsequent to the instructions erroneously issued assuming no occurrence of an exception upon the detection of a first exception;
a third instruction control unit operable, in the event of the detection of a second exception in an earlier instruction after the issuance of exception handling routine instructions in the correct direction following the detection of the first exception, to cancel the exception handling routine instructions issued as a result of the detection of the occurrence of the first exception and thereafter start issuing exception handling routine instructions in the correct direction based on the detection of the occurrence of the second exception; and
a fourth instruction control unit operable, after the issuance of the exception handling routine instructions following the detection of the occurrence of the second exception, to cancel the instruction that caused the first exception and the instructions erroneously issued assuming no occurrence of an exception in response to the completion of all the instructions prior to the earlier exception occurrence instruction, and thereafter resume the issuance of exception handling routine instructions based on the occurrence of the second exception.

16. A processor comprising:
a first instruction control unit operable to issue instructions including an exception occurrence instruction with a first identifier attached thereto and speculatively execute the instructions assuming no occurrence of an exception;
a second instruction control unit operable to issue exception handling routine instructions with a second identifier attached thereto subsequent to the instructions erroneously issued assuming no occurrence of an exception upon the detection of a first exception; and
a third instruction control unit operable, in the event of the detection of a second exception in a new instruction which is one of the exception handling routine instructions after the start of the issuance of exception handling routine instructions in the correct direction following the detection of the first exception, to cancel the exception occurrence instruction and all the subsequent instructions in response to the completion of all the instructions prior to the new exception occurrence instruction, and thereafter start issuing exception handling routine instructions based on the occurrence of the first exception.

17. A processor comprising:
a first instruction control unit operable to issue instructions including an exception occurrence instruction with a first identifier attached thereto and speculatively execute the instructions assuming no occurrence of an exception;
a second instruction control unit operable to issue exception handling routine instructions with a second identifier attached thereto subsequent to the instructions erroneously issued assuming no occurrence of an exception upon the detection of a first exception;
a third instruction control unit operable, in the event of the detection of a second exception in a new instruction which is one of the exception handling routine instructions after the start of the issuance of exception handling routine instructions in the correct direction following the detection of the first exception, to cancel the earlier exception occurrence instruction and the instructions that were erroneously issued assuming no occurrence of an exception in response to the completion of all the instructions prior to the earlier exception occurrence instruction that caused the first exception while disabling the issuance of the exception handling routine instructions, and enable the issuance of instructions to start issuing the exception handling routine instructions in the correct direction based on the occurrence of the second exception; and
a fourth instruction control unit operable, after the issuance of the exception handling routine instructions based on the occurrence of the second exception, to cancel the instruction that caused the second exception and the instructions that were issued as the exception handling routine instructions based on the occurrence of the first exception in response to the completion of all the instructions prior to the new exception occurrence instruction, and thereafter resume the issuance of exception handling routine instructions based on the occurrence of the second exception.

18. An instruction control method for a processor, the method comprising:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of an exception; and
a third step of canceling the exception occurrence instruction and the instructions erroneously issued assuming no occurrence of an exception and starting issuing the exception handling routine instructions after the completion of all the instructions prior to the exception occurrence instruction.

19. An instruction control method for a processor, the method comprising:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception; and
a third step, in the event of the detection of a second exception in an earlier instruction after the issuance of exception handling routine instructions in the correct direction following the detection of the first exception, of canceling the exception occurrence instruction and all the subsequent instructions in response to the completion of all the instructions prior to the earlier exception occurrence instruction, and thereafter starting issuing exception handling routine instructions based on the detection of the second exception.

20. An instruction control method for a processor, the method comprising:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception;
a third step, in the event of the detection of a second exception in an earlier instruction after the issuance of exception handling routine instructions in the correct direction following the detection of the first exception, of canceling the exception handling routine instructions issued as a result of the detection of the occurrence of the first exception and thereafter starting issuing exception handling routine instructions in the correct direction based on the detection of the occurrence of the second exception; and
a fourth step, after the issuance of the exception handling routine instructions following the detection of the occurrence of the second exception, of canceling the instruction that caused the first exception and the instructions erroneously issued assuming no occurrence of an exception in response to the completion of all the instructions prior to the earlier exception occurrence instruction, and thereafter resuming the issuance of exception handling routine instructions based on the occurrence of the second exception.

21. An instruction control method for a processor, the method comprising:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception; and
a third step, in the event of the detection of a second exception in a new instruction which is one of the exception handling routine instructions after the start of the issuance of exception handling routine instructions in the correct direction following the detection of the first exception, of canceling the exception occurrence instruction and all the subsequent instructions in response to the completion of all the instructions prior to the new exception occurrence instruction, and thereafter starting issuing exception handling routine instructions based on the occurrence of the first exception.

22. An instruction control method for a processor, the method comprising:
a first step of issuing instructions including an exception occurrence instruction with a first identifier attached thereto and speculatively executing the instructions assuming no occurrence of an exception;
a second step of issuing exception handling routine instructions with a second identifier attached thereto subsequent to the instructions erroneously issued assuming no occurrence of an exception upon the detection of a first exception;
a third step, in the event of the detection of a second exception in a new instruction which is one of the exception handling routine instructions after the start of the issuance of exception handling routine instructions in the correct direction following the detection of the first exception, of canceling the earlier exception occurrence instruction and the instructions that were erroneously issued assuming no occurrence of an exception in response to the completion of all the instructions prior to the earlier exception occurrence instruction that caused the first exception while disabling the issuance of the exception handling routine instructions, and thereafter enabling the issuance of instructions to start issuing the exception handling routine instructions in the correct direction based on the occurrence of the second exception; and
a fourth step, after the issuance of the exception handling routine instructions based on the occurrence of the second exception, of canceling the instruction that caused the second exception and the instructions that were issued as the exception handling routine instructions based on the occurrence of the first exception in response to the completion of all the instructions prior to the new exception occurrence instruction, and resuming the issuance of exception handling routine instructions based on the occurrence of the second exception.
